(19) United States
(12) Patent Application Publication
(10) Pub. No.: US 2026/0353138 A1
(43) Pub. Date: Nov. 5, 2026

(54) RVQOE MEASUREMENT AND REPORTING FOR DUAL CONNECTIVITY

(71) Applicant: Telefonaktiebolaget LM Ericsson (PUBL), Stockholm (SE)

(72) Inventors: Filip Barac, HUDDINGE (SE); Johan Rune, LIDINGÖ (SE); Luca Lunardi, GENOVA (IT); Cecilia Eklöf, TÄBY (SE); Agne Åberg Larsson, UPPSALA (SE); Vengatanathan Krishnamoorthi, LINKÖPING (SE)

(21) Appl. No.: 19/125,623

(22) PCT Filed: Nov. 3, 2023
(86) PCT No.: PCT/SE2023/051122

§ 371 Date: Apr. 29, 2025

Related U.S. Application Data
(60) Provisional application No. 63/382,238, filed on Nov. 3, 2022.

(51) Int. Cl. H04W 24/10; H04W 24/02

(52) U.S. Cl. CPC H04W 24/10; H04W 24/02

(57) ABSTRACT

According to some embodiments, a method is performed by a wireless device operating in dual connectivity with a first network node and a second network node. The method comprises: receiving a radio access network visible quality of experience (RVQoE) configuration associated with an application session; determining whether the application session is provided by communication with both the first network node and the second network node; and transmitting a RVQoE report for the application session based on the determination of whether the application session is provided by communication with both the first network node and the second network node.

### TECHNICAL FIELD

Embodiments of the present disclosure are directed to wireless communications and, more particularly, to ran visible quality of experience (RVQoE) measurement and reporting for dual connectivity (DC).

### BACKGROUND

FIG. 1 illustrates the current next generation (NG) radio access network (RAN) architecture (3GPP TS 38.401). The NG-RAN consists of a set of gNBs connected to the fifth generation core (5GC) through the NG interface. As specified in 38.300, the NG-RAN may also consist of a set of ng-eNBs, an ng-eNB may consist of an ng-eNB central unit (CU) and one or more ng-eNB distributed units DU(s). An ng-eNB-CU and an ng-eNB-DU are connected via the W1 interface. The general principles described herein also apply to the ng-eNB and the W1 interface, if not explicitly specified otherwise.

A gNB can support frequency division duplex (FDD) mode, time division duplex (TDD) mode or dual mode operation. The Xn interfaces interconnects gNBs.

A gNB may consist of a gNB-CU and one or more gNB-DU(s). A gNB-CU and a gNB-DU are connected via the F1 interface. One gNB-DU is connected to only one gNB-CU. The NG, Xn and F1 are logical interfaces.

For NG-RAN, the NG and Xn-C interfaces for a gNB consisting of a gNB-CU and gNB-DUs, terminate in the gNB-CU. For EN-DC, the S1-U and X2-C interfaces for a gNB consisting of a gNB-CU and gNB-DUs, terminate in the gNB-CU. The gNB-CU and connected gNB-DUs are only visible to other gNBs and the 5GC as a gNB.

The node hosting the user plane part of the New Radio (NR) Packet Data Convergence Protocol (PDCP) (e.g., gNB-CU, gNB-CU-UP, and for EN-DC, MeNB or SgNB depending on the bearer split) shall perform user inactivity monitoring and further informs its inactivity or (re)activation to the node having control plane connection towards the core network (e.g., over E1, X2). The node hosting NR Radio Link Control (RLC) (e.g. gNB-DU) may perform user inactivity monitoring and further inform its inactivity or (re)activation to the node hosting the control plane, e.g. gNB-CU or gNB-CU-CP.

Uplink (UL) PDCP configuration (i.e., how the UE uses the UL at the assisting node) is indicated via X2-C (for EN-DC), Xn-C (for NG-RAN) and F1-C. Radio link outage/resume for downlink (DL) and/or UL is indicated via X2-U (for EN-DC), Xn-U (for NG-RAN) and F1-U.

The NG-RAN is layered into a Radio Network Layer (RNL) and a Transport Network Layer (TNL). The NG-RAN architecture, i.e. the NG-RAN logical nodes and interfaces between them, is defined as part of the RNL. For each NG-RAN interface (NG, Xn, F1) the related TNL protocol and the functionality are specified. The TNL provides services for user plane transport and signalling transport.

In NG-Flex configuration, each NG-RAN node is connected to all access and mobility management functions (AMFs) of AMF sets within an AMF region supporting at least one slice also supported by the NG-RAN node. The AMF set and the AMF region are defined in 3GPP TS 23.501.

If security protection for control plane and user plane data on TNL of NG-RAN interfaces is to be supported, NDS/IP 3GPP TS 33.501 shall be applied.

FIG. 2 illustrates he overall architecture for separation of gNB-CU-CP and gNB-CU-UP, and is specified in TS 37.483. A gNB may consist of a gNB-CU-CP, multiple gNB-CU-UPs and multiple gNB-DUs. The gNB-CU-CP is connected to the gNB-DU through the F1-C interface. The gNB-CU-UP is connected to the gNB-DU through the F1-U interface. The gNB-CU-UP is connected to the gNB-CU-CP through the E1 interface. One gNB-DU is connected to only one gNB-CU-CP. One gNB-CU-UP is connected to only one gNB-CU-CP.

For resiliency, a gNB-DU and/or a gNB-CU-UP may be connected to multiple gNB-CU-CPs by appropriate implementation.

One gNB-DU can be connected to multiple gNB-CU-UPs under the control of the same gNB-CU-CP. One gNB-CU-UP can be connected to multiple DUs under the control of the same gNB-CU-CP.

The connectivity between a gNB-CU-UP and a gNB-DU is established by the gNB-CU-CP using bearer context management functions. The gNB-CU-CP selects the appropriate gNB-CU-UP(s) for the requested services for the UE. For multiple CU-Ups, they belong to the same security domain as defined in TS 33.210. Data forwarding between gNB-CU-UPs during intra-gNB-CU-CP handover within a gNB may be supported by Xn-U.

In dual connectivity (DC), a UE capable of multiple transmission/receptions may be connected to more than one RAN node. The RAN nodes may be of the same radio access technology (RAT) (both master node and secondary node in NR or Long Term Evolution (LTE), respectively) or different RATs, e.g. one master LTE node and one secondary NR node. Specification TS 37.340 describes the principles of multi-radio dual connectivity as follows:

=======================Start of Excerpt from TS 37.340====================

### 4.1 General

### 4.1.1 Common MR-DC Principles

Multi-Radio Dual Connectivity (MR-DC) is a generalization of the Intra-E-UTRA Dual Connectivity (DC) described in TS 36.300, where a multiple Rx/Tx capable UE may be configured to utilise resources provided by two different nodes connected via non-ideal backhaul, one providing NR access and the other one providing either E-UTRA or NR access. One node acts as the MN and the other as the SN. The MN and SN are connected via a network interface and at least the MN is connected to the core network. The MN and/or the SN can be operated with shared spectrum channel access.

All functions specified for a UE may be used for an IAB-MT unless otherwise stated. Similar as specified for UE, the IAB-MT can access the network using either one network node or using two different nodes with EN-DC and NR-DC architectures. In EN-DC, the backhauling traffic over the E-UTRA radio interface is not supported.
NOTE 1: MR-DC is designed based on the assumption of non-ideal backhaul between the different nodes but can also be used in case of ideal backhaul.
NOTE 2: All MR-DC normative text and procedures in this version of the specification show the aggregated node case. The details about non-aggregated node for MR-DC operation are described in TS 38.401.
   4.1.2 MR-DC with the EPC

E-UTRAN supports MR-DC via E-UTRA-NR Dual Connectivity (EN-DC), in which a UE is connected to one eNB that acts as a MN and one en-gNB that acts as a SN. The eNB is connected to the EPC via the S1 interface and to the en-gNB via the X2 interface. The en-gNB might also be connected to the EPC via the S1-U interface and other en-gNBs via the X2-U interface.

The EN-DC architecture is illustrated in FIG. 4.1.2-1 (and reproduced as FIG. 3 herein).

4.1.3 MR-DC with the 5GC

### 4.1.3.1 E-UTRA-NR Dual Connectivity

NG-RAN supports NG-RAN E-UTRA-NR Dual Connectivity (NGEN-DC), in which a UE is connected to one ng-eNB that acts as a MN and one gNB that acts as a SN.

### 4.1.3.2 NR-E-UTRA Dual Connectivity

NG-RAN supports NR-E-UTRA Dual Connectivity (NE-DC), in which a UE is connected to one gNB that acts as a MN and one ng-eNB that acts as a SN.

### 4.1.3.3 NR-NR Dual Connectivity

NG-RAN supports NR-NR Dual Connectivity (NR-DC), in which a UE is connected to one gNB that acts as a MN and another gNB that acts as a SN. In addition, NR-DC can also be used when a UE is connected to two gNB-DUs, one serving the MCG and the other serving the SCG, connected to the same gNB-CU, acting both as a MN and as a SN.

=========================End of Excerpt from TS 37.340====================

The flows for setting up dual connectivity is described in chapter 10 TS 37.340. FIG. 10.2.1-1 is a signaling diagram illustrating a secondary node addition procedure (reproduced as FIG. 4 herein).

Quality of experience (QoE) measurements, also referred to as “application layer measurements,” have been specified for LTE and universal mobile telecommunication service (UMTS) and are being specified for NR in 3GPP release 17. The purpose of the application layer measurements is to measure the end user experience when using certain applications. Currently QoE measurements for streaming services and for MTSI (Mobility Telephony Service for IMS) services are supported. For NR, it is likely that at least virtual reality (VR) is added to the list of services for which QoE measurements are specified and supported.

The solutions in LTE and UMTS are similar with the overall principles as follows. Quality of experience measurement collection (QMC) enables configuration of application layer measurements in the user equipment (UE) and transmission of QoE measurement result files (commonly referred to as QoE reports) to the network by Radio Resource Control (RRC) signaling. An application layer measurement configuration (also referred to as QoE measurement configuration or QoE configuration) that the RAN receives from the operations and management (OAM) system or the core network (CN) is encapsulated in a transparent container, which is forwarded to a UE in a downlink RRC message. An application layer measurement report (also referred to as a QoE report) that the UE access stratum (UE AS) or UE RRC layer receives from the UE's higher layer (application layer) is encapsulated in a transparent container and sent to the network in an uplink RRC message. The RAN then forwards the QoE report to a measurement collector entity (MCE).

In 3GPP release 17 a new study item for “Study on NR QoE management and optimizations for diverse services” for NR has been approved and concluded. The specification work for 3GPP release 17 is still ongoing. The purpose of the study item is to study solutions for QoE measurements in NR. QoE management in NR will not just collect the quality of experience parameters of streaming services but also consider the typical performance requirements of diverse services (e.g., augmented reality (AR)/VR and ultra-reliable low-latency communication (URLLC), of which at least VR seems to be covered in 3GPP release 17). Based on requirements of services, the NR study also included more adaptive QoE management schemes that enable network optimization to satisfy user experience for diverse services.

The configuration data related to QoE measurements (in standard specifications typically referred to as application layer measurements) consists of a service type indication, an indication of an area in which the measurements are to be performed (denoted area scope), an Internet protocol (IP) address of the entity the collected measurement results (i.e., the QoE reports) should be sent to (often referred to as a MCE, but the entity may sometimes also be referred to as a trace collection entity (TCE)) and a set of instructions of which type of measurements that should be performed and details of how the measurements are to be performed. The instructions are intended for the application layer in the UE and are placed in a “container” that the network entities handling it, e.g. forwarding it to the UE, as well as the UE access stratum, cannot interpret and do not try to read.

The currently specified service types are MTSI and streaming service (DASH), and in 3GPP release 17, at least service type VR will be added.

An area scope is defined in terms of cells or network related areas. In UMTS, an area scope is defined as either a list of cells, a list of routing areas or a list of tracking areas. In LTE, an area scope is defined as either a list of cells or a list of tracking areas. In NR, an area scope will be defined as either a list of cells or a list of tracking areas.

QoE, and in particular QoE configuration, comes in two flavors: management-based QoE configuration and signaling-based QoE configuration. In both cases the QoE configuration originates in the OAM system or some other administrational entity, e.g., dealing with customer satisfaction. All of these entities are referred to herein as the OAM system (where the OAM system also contains further entities). With management-based QoE (m-based QoE), the OAM system is typically interested in general QoE statistics from a certain area (which is configured as an area scope). The m-based QoE configuration is sent directly from the OAM system to the RAN nodes controlling cells that are within the area scope. Each RAN node then selects UEs that are within the area scope (and also fulfills any other relevant condition, such as supporting the concerned application/service type) and sends the m-based QoE configuration to these UEs.

With signaling-based QoE (s-based QoE), the OAM system is interested in collecting QoE measurement results from a specific UE, e.g. because the user of the UE has filed a complaint. The OAM system sends the s-based QoE configuration to the home subscriber server (HSS) (in Evolved Packet System (EPS)/LTE) or unified data management (UDM) (in 5GS/NR), which forwards the QoE configuration to the UE's current core network node, e.g. a mobility management entity (MME) in EPS/LTE or an access and mobility management function (AMF) in 5G/NR. The core network then forwards the s-based QoE configuration to the RAN node that serves the concerned UE and the RAN forwards it to the UE.

Forwarded to the UE are the service type indication and the container with the measurement instructions. The UE is not aware of whether a received QoE configuration is m-based or s-based. In legacy systems, the QoE framework is integrated with the trace functionality and a trace identifier is associated with each QoE configuration. In NR, the QoE functionality will be logically separated from the trace functionality, but it will still partly reuse the trace signaling mechanisms.

In NR and LTE, a globally unique QoE reference (formed of mobility country code (MCC)+mobile network code (MNC)+QoE measurement collection (QMC) identifier (ID) is a string of 24 bits) will be associated with each QoE configuration. The QoE reference is included in the container with measurement instructions and also sent to the RAN (i.e. the gNB in NR). For the communication between the gNB and the UE, the QoE reference is replaced by a shorter identifier denoted as measConfigAppLayerId, which is locally unique within a UE (i.e. there is a one-to-one mapping between a measConfigAppLayerId and a QoE reference for each QoE configuration provided to a UE. The measConfigAppLayerId is stored in the UE access stratum and also forwarded in an attention (AT) command (which is the type of instructions used in the communication between the UE's modem part and the UE's application layer) together with the service type indication and the container with the measurement instructions.

Reports with collected QoE measurement results (QoE reports) are sent from the UE application layer to the UE access stratum, which forwards them to the RAN, which forwards them to the MCE. These QoE measurement results are placed in a “container”, which is uninterpretable for the UE access stratum and the RAN. QoE reporting can be configured to be periodic or only sent at the end of an application session. Furthermore, the RAN can instruct the UE to pause QoE reporting, e.g. if the cell/gNB is in a state of overload.

The RAN is not aware of when an application session with an associated QoE measurement session is ongoing and the UE access stratum is also not automatically aware of this. To alleviate this, session start/stop indications can be introduced, which will be sent from the application layer in the UE to the UE AS and from the UE AS to the RAN. A session stop indication may be implicit in the form of a QoE report sent when the application session and the associated QoE measurement session are concluded.

The RAN may decide to release a QoE configuration in a UE at any time, as an implementation-based decision. Typically, it is done when the UE has moved outside an area configured for the QoE measurements, commonly referred to as the area scope.

One opportunity provided by legacy solutions is also to be able to keep the QoE measurement for the whole session, even during a handover situation. It is also discussed to let the UE continue with the QoE measurements on an ongoing application session until the application session ends, even if the UE in the meantime moves out of the configured area scope.

In NR, 3GPP Rel-17 introduced RAN visible QoE measurements, and a general description can be found in 3GPP TS 38.300 v17.0.0 clause 21.4.

RAN visible QoE measurements are configured by the NG-RAN node, where a subset of QoE metrics is reported from the UE as an explicit information element (IE) readable by the NG-RAN node. RAN visible QoE measurements (e.g., RAN visible QoE metrics, RAN visible QoE values) may be used by the NG-RAN node for network optimization. RAN visible QoE measurements are supported for the DASH streaming and VR services. The NG-RAN node configures the RAN visible QoE measurement to collect all or some of the available RAN visible QoE metrics, where the indication of metric availability is received from the OAM or CN. The set of available RAN visible QoE metrics is a subset of the metrics that are already configured as part of QoE measurement configuration encapsulated in the transparent container. The protocol data unit (PDU) session identifier(s) corresponding to the service that is subject to QoE measurements may also be reported by the UE along with the RAN visible QoE measurement results.

A request for collecting QoE measurements not visible to RAN (also referred to as OAM-QoE in R3-223290) is started from OAM and identified by a QoE reference. A definition for this identifier can be found e.g. in 3GPP TS 28.405 v17.1.0, clause 5.2.

The QoE reference parameter specifies the network request session. The QoE reference shall be globally unique therefore it is composed as follows. MCC+MNC+QMC ID, where the MCC and MNC are coming with the QMC activation request from the management system to identify one public land mobile network (PLMN) containing the management system, and QMC ID is a 3 byte Octet String. The QMC ID is generated by the management system or the operator. It is used to identify the QoE measurement collection job in the traffic nodes and in the measurement collection center.

The UE AS layer can report to a gNB the RAN visible QoE measurements in RRC format and a UE application layer can be configured for performing more application layer measurements at the same time (in NR Rel-17 up to 16) and, e.g. in TS 38.331, an application layer measurement is identified by the MeasConfigAppLayerId IE.

In a gNB, RAN visible QoE information can be transferred from gNB-CU to the gNB-DU in a procedure described in TS 38.473 v17.0.0. The procedure is UE-associated, i.e. it is specific for a UE.

The purpose of the QoE information transfer procedure is to transfer RAN visible QoE information from the gNB-CU to the gNB-DU. The procedure uses UE-associated signaling. An example is illustrated in FIG. 5.

FIG. 5 is a signaling diagram illustrating a QoE information transfer procedure. The gNB-CU initiates the procedure by sending the QOE INFORMATION TRANSFER message to the gNB-DU. If the QoE Information List IE is included in QOE INFORMATION TRANSFER message, the gNB-DU may take it into account according to TS 38.300.

The QOE INFORMATION TRANSFER message is sent by a gNB-CU to a gNB-DU, to indicate information related to RAN visible QoE.

| | | | IE type and | Semantics | | Assigned |
|---|---|---|---|---|---|---|
| IE/Group Name | Presence | Range | reference | description | Criticality | Criticality |
| Message Type | M | | 9.3.1.1 | | YES | ignore |
| gNB-CU UE F1AP ID | M | | 9.3.1.4 | | YES | reject |
| gNB-DU UE F1AP ID | M | | 9.3.1.5 | | YES | reject |
| QoE Information List | | | 0 . . . 1 | | YES | ignore |
| >QoE Information Item | | | 1 . . . <maxnoofQoEIn- | | Each | ignore |
| | | | formation> | | | |
| >>QoE Metrics | O | | 9.3.1.260 | | — | — |

| Range bound | Explanation |
|---|---|
| maxnoofQoEInformation | Maximum no. of QoE information for one UE, the maximum value is 16. |

The QoE Metrics IE provides the RAN visible QoE measurement report to gNB-DU.

| | | | | |
|---|---|---|---|---|
| | | | IE type and | Semantics |
| IE/Group Name | Presence | Range | reference | description |

| | | | |
|---|---|---|---|
| Buffer Level | O | OCTET | As defined |
| | | STRING | in TS 38.331. |
| Playout Delay | O | OCTET | As defined |
| | | STRING | in TS 38.331. |

In the contribution R3-223128 to 3GPP TSG-RAN WG3 Meeting #116-e, the association of RAN visible QoE report to a reference is discussed.

In F1AP a list containing RVQoE metric is transferred over F1 using UE-associated signaling, but the reports are not associated with, e.g., any reference or other identifier. Thus, the gNB-DU will not know how many different application sessions that provide reports, and the currently defined signaling will therefore not enable the gNB-DU to distinguish between QoE reports coming from the different application sessions. Also, the gNB-DU will not be able to group reports that it successively receives from a given application session and will therefore not be able to trace, e.g., any tendencies in the reported data.

A candidate reference or other identifier that could solve this issue would typically be the QoE reference or the short RRC ID (measConfigAppLayerId) allocated by the UE. The F1AP change request R3-223131 proposes to use the QoE reference, but the ultimate choice may be subject for further evaluation.

The same contribution discusses identifying RVQoE report information over F1 using QoE reference or short RRC ID (measConfigAppLayerId).

Signalling radio bearers (SRBs) are configured in the UE for transmission of control plane message to and from the UE. In current specifications, five different SRBs may be configured. SRB0 is used for initial RRC setup before any security is activated. SRB1 is used for most RRC messages and SRB2 for non-access stratum (NAS) messages.

If the UE is configured with dual connectivity (DC), SRB1 is used for communicating with the master node (MN). The UE may in DC also be configured with SRB3, which is used for direct communication between the UE and the secondary node (SN).

For the transmission of QoE and RVQoE reports, a dedicated SRB4 has been defined. SRB4 is in Rel-17 only being used for transmission of QoE and RVQoE reports in the RRC message MeasurementReportAppLayer, to a master node, or to a gNB in single connectivity mode.

There currently exist certain challenges. As one example, in Rel-18, QoE and RAN visible QoE (RVQoE) measurement collection and reporting will be supported for the UEs in NR dual connectivity (NR-DC). Two essential requirements for RVQoE are:
Requirement 1: The node that delivers the data for the application session to and from the UE should participate in assembling the RVQoE measurement configuration.
Requirement 2: The RVQoE reports should be delivered to the node that delivers the data for the application session to and from the UE.

Some proposals describe how to ensure the compliance with the above principles when either the MN or the SN carries the data for the application session to the UE. However, it is unclear how to ensure the compliance with the above principles if the data for the application session is delivered to the UE by both the MN and the SN.

There are two scenarios. In a first scenario, the application session has multiple data flows, e.g. one for video and one for audio, and different data flows are sent over different DC legs. In a second scenario, the application session has one or more data flow(s), and each flow is carried over both DC connectivity legs using a split data radio bearer (DRB).

For the first scenario, given that the UE application layer generates the RVQoE reports and that each report pertains to the entire data flow(s) of the session (rather than, e.g., only one of the bearers), if the session is carried by both nodes in a way that at one data flow is carried by the MN connectivity leg while another data flow is carried by the SN connectivity leg, it is unclear which part of the RVQoE report is relevant for which of the two RAN nodes serving the UE.

In the second scenario, i.e. when a split bearer (or multiple split bearers) is used to carry the application session data flow(s), a challenge is that neither the MN nor the SN can independently control adaptations of the treatment of the application session data flow(s), such as scheduling priority adaptations. This may result in that the MN's and the SN's adaptations either counteract each other or amplify each other in an undesirable way that, e.g., may result in overcompensation.

### SUMMARY

As described above, certain challenges currently exist with ran visible quality of experience (RVQoE) measurement and reporting for dual connectivity (DC). Certain aspects of the present disclosure and their embodiments may provide solutions to these or other challenges. For example, particular embodiments enable RVQoE measurement configuration and reporting for a user equipment (UE) in multi-connectivity when the data for the application session is carried via more than one multi-connectivity leg. For New Radio (NR) DC this concerns the RVQoE measurement configuration and reporting when the data for the application session is delivered to the UE by both the master node (MN) and the secondary node (SN). For this scenario, particular embodiments fulfill the above mentioned essential Requirements 1 and 2 for RVQoE measurements and reporting.

According to some embodiments, a method is performed by a wireless device operating in dual connectivity with a first network node and a second network node. The method comprises: receiving a RVQoE configuration associated with an application session; determining whether the application session is provided by communication with both the first network node and the second network node; and transmitting a RVQoE report for the application session based on the determination of whether the application session is provided by communication with both the first network node and the second network node.

In particular embodiments, determining whether the application session is provided by communication with both the first network node and the second network node comprises receiving a reporting configuration in the RVQoE configuration indicating whether RVQoE reporting is towards the first network node, the second network node, or both the first and second network node.

In particular embodiments, determining whether the application session is provided by communication with both the first network node and the second network node is based on an association between the application session and one or more bearer channels.

In particular embodiments, the method further comprises: transmitting the association between the application session and one or more bearer channels to one or both of the first network node and the second network node; and receiving from one or both of the first network node and the second network node an updated RVQoE configuration comprising a reporting configuration indicating whether RVQoE reporting is towards the first network node, the second network node, or both the first and second network node based on the association between the application session and one or more bearer channels.

In particular embodiments, receiving the RVQoE configuration occurs after a start of the application session, and the RVQoE configuration comprises an indication of whether RVQoE reporting is towards the first network node, the second network node, or both the first and second network node based on protocols used by the application session.

In particular embodiments, receiving the RVQoE configuration occurs after a start of the application session, and after a first RVQoE report has been transmitted by the wireless device, and the RVQoE configuration comprises an indication of whether RVQoE reporting is towards the first network node, the second network node, or both the first and second network node based on the first RVQoE report.

According to some embodiments, a wireless device comprises processing circuitry operable to perform any of the methods of the wireless receiver described above.

Also disclosed is a computer program product comprising a non-transitory computer readable medium storing computer readable program code, the computer readable program code operable, when executed by processing circuitry to perform any of the methods performed by the wireless device described above.

According to some embodiments, a method is performed by a first network node operating in dual connectivity with a second network node. The method comprises determining whether an application session is provided by communication with both the first network node and the second network node and configuring a wireless device with a RVQoE configuration associated with the application session. The RVQoE configuration comprises a reporting configuration indicating whether RVQoE reporting is towards the first network node, the second network node, or both the first and second network node based on whether the application session is provided by communication with both the first network node and the second network node. The method further comprises receiving a RVQoE report for the application session from the wireless device based on the reporting configuration.

In particular embodiments, determining whether the application session is provided by communication with both the first network node and the second network node is based on an association between the application session and one or more bearer channels.

In particular embodiments, determining whether the application session is provided by communication with both the first network node and the second network node comprises receiving the association between the application session and one or more bearer channels from the wireless device.

In particular embodiments, determining whether the application session is provided by communication with both the first network node and the second network node is based on protocols used by the application session.

In particular embodiments, determining whether the application session is provided by communication with both the first network node and the second network node occurs after a first RVQoE report has been transmitted by the wireless device and the determination is based on the first RVQoE report.

In particular embodiments, the first network node comprises a MN and the second network node comprises a SN, or the first network node comprises a SN and the second network node comprises a MN.

In particular embodiments, the method further comprises forwarding the received RVQoE report to the second network node.

According to some embodiments, a network node comprises processing circuitry operable to perform any of the methods of the network node described above.

Also disclosed is a computer program product comprising a non-transitory computer readable medium storing computer readable program code, the computer readable program code operable, when executed by processing circuitry to perform any of the methods performed by the network node described above.

Certain embodiments may provide one or more of the following technical advantages. For example, particular embodiments make it feasible to conduct meaningful RVQoE measurements and reporting even if the data for the application session is delivered to/from the UE by both the MN and the SN (or towards both the MN and the SN).

### BRIEF DESCRIPTION OF THE DRAWINGS

For a more complete understanding of the disclosed embodiments and their features and advantages, reference is now made to the following description, taken in conjunction with the accompanying drawings, in which:

FIG. 1 illustrates the current next generation (NG) radio access network (RAN) architecture;

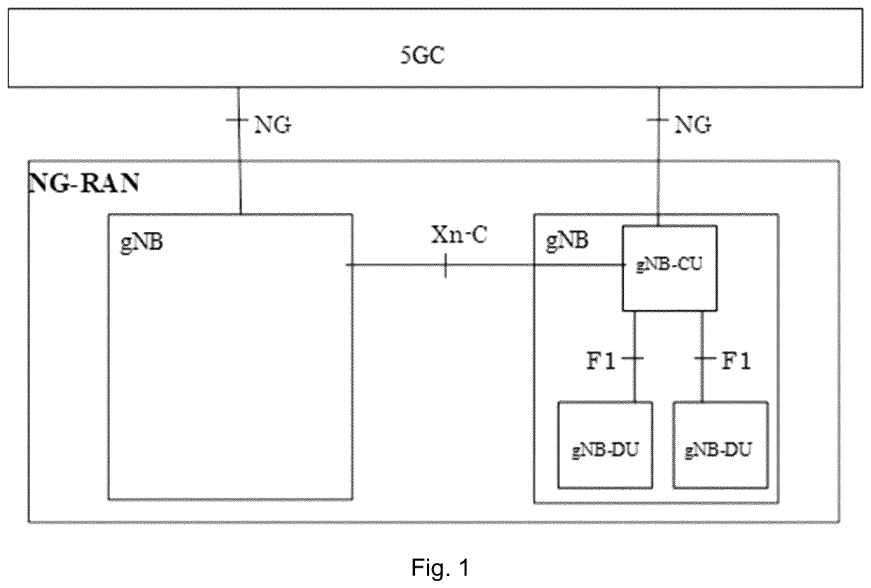

FIG. 2 illustrates he overall architecture for separation of gNB-CU-CP and gNB-CU-UP;

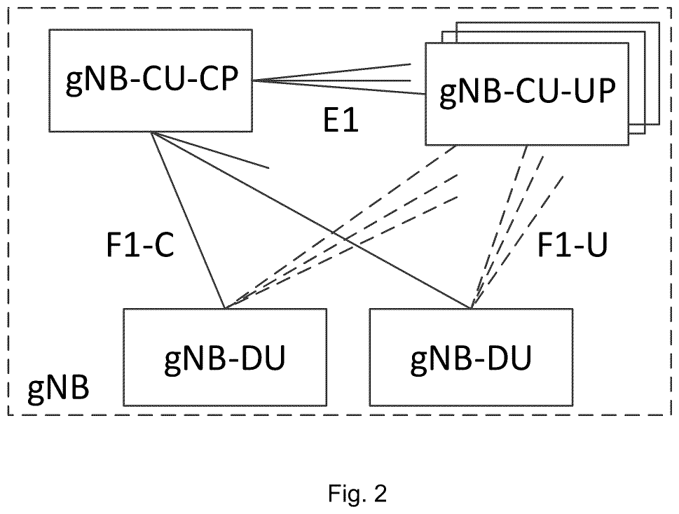

FIG. 3 illustrates the EN-DC overall architecture;

FIG. 4 is a signaling diagram illustrating a secondary node addition procedure;

FIG. 5 is a signaling diagram illustrating a quality of experience (QoE) information transfer procedure;

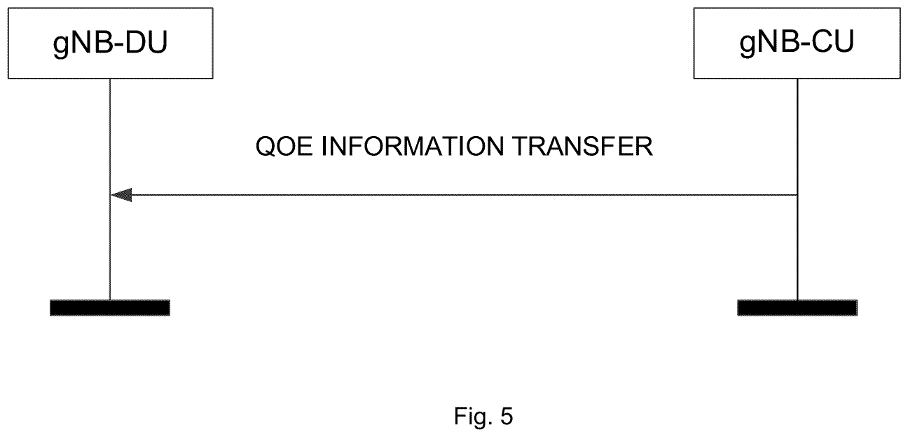

FIG. 6 illustrates an example communication system, according to certain embodiments;

FIG. 7 illustrates an example user equipment (UE), according to certain embodiments;

FIG. 8 illustrates an example network node, according to certain embodiments;

FIG. 9 illustrates a block diagram of a host, according to certain embodiments;

FIG. 10 illustrates a virtualization environment in which functions implemented by some embodiments may be virtualized, according to certain embodiments;

FIG. 11 illustrates a host communicating via a network node with a UE over a partially wireless connection, according to certain embodiments;

FIG. 12 illustrates a method performed by a wireless device, according to certain embodiments; and

FIG. 13 illustrates a method performed by a network node, according to certain embodiments.

### DETAILED DESCRIPTION

As described above, certain challenges currently exist with ran visible quality of experience (RVQoE) measurement and reporting for dual connectivity (DC). Certain aspects of the present disclosure and their embodiments may provide solutions to these or other challenges. For example, particular embodiments enable RVQoE measurement configuration and reporting for a user equipment (UE) in multi-connectivity when the data for the application session is carried via more than one multi-connectivity leg. For New Radio (NR) DC this concerns the RVQoE measurement configuration and reporting when the data for the application session is delivered to the UE by both the master node (MN) and the secondary node (SN).

Particular embodiments are described more fully with reference to the accompanying drawings. Other embodiments, however, are contained within the scope of the subject matter disclosed herein, the disclosed subject matter should not be construed as limited to only the embodiments set forth herein; rather, these embodiments are provided by way of example to convey the scope of the subject matter to those skilled in the art.

Particular embodiments herein are described with respect to NR-DC, but may be generalized to multiple-radio dual connectivity (MR-DC) or to connectivity options with more than two SN nodes as well.

Particular embodiments apply to multi-radio dual connectivity where the radio access network (RAN) nodes involved pertains to the same radio access technology (RAT) or to different RATs.

Particular embodiments are described with respect to the scenario where both nodes serving a UE in NR-DC carry the application session, but some embodiments are equally applicable where only one of the MN and SN carries the session.

The terms “application layer measurement configuration”, “application measurement configuration”, “RVQoE measurement configuration”, “RVQoE configuration”, “RVQoE measurement and reporting configuration” and “QMC configuration” are used interchangeably. Note that the “QMC configuration file” is not an equivalent term, but instead refers to the part of the SN configuration consisting of an XML file containing instructions of SN metrics to be collected, etc.

A network node can be a RAN node, a gNB, an eNB, an en-gNB, a ng-eNB, a gNB-CU, a gNB-CU-CP, a gNB-CU-UP, an eNB-CU, an eNB-CU-CP, an eNB-CU-UP, an integrated access and backhaul (IAB)-node, an IAB-donor DU, an IAB-donor-CU, an IAB-DU, an IAB-MT, an O-CU, an O-CU-CP, an O-CU-UP, an O-DU, an O-RU, an O-eNB, a non-real time RAN intelligent controller (Non-RT RIC), a real-time RAN intelligent controller (RT-RIC), an operation and management (OAM) node, a core network node/function, a cloud-based network function, and/or a cloud-based centralized training node.

All references to the application layer are with respect to the application layer of the UE (RAN nodes do not have an application layer).

The term “service” is often used as a short notation for “service type,” therefore “service” and “service types” may be used interchangeably unless explicitly stated otherwise.

Particular embodiments apply to both signaling- and management-based RVQoE measurements (but may also optionally be restricted to apply to only one of them).

The terms “RVQoE report” and “RVQoE measurement report” are used interchangeably.

The terms “access stratum” and “radio layer” are used interchangeably when referring to a UE.

The term “session” refers to an application session for which RVQoE measurement is applied.

Particular embodiments apply to universal mobile telecommunication service (UMTS), long Term Evolution (LTE) and NR as well as future RATs such as sixth generation (6G).

Particular embodiments are described with respect to signaling based RVQoE measurements, but the embodiments are equally applicable to both management-based and signaling-based RVQoE measurements.

When it is stated that the RAN performs a certain action, it may mean that the MN, or the SN or both MN and SN, or one of them, after coordinating with the other, performs it.

The formulation “both nodes” refers to the MN and the SN. MN and SN may refer to master cell group (MCG) and secondary cell group (SCG).

Particular embodiments are described in a stepwise manner, in the following sequence that, in some cases may not be followed strictly, i.e., reiterations or skipping of some steps may be possible:
RVQoE configuration assembly,
delivering the configuration to the UE,
determining that/whether both MN and SN carry the session,
acting upon the fact that both nodes carry the session or only one node carries the session, and
reporting the RVQoE measurements.

Some embodiments include configuration of the UE with RVQoE measurements. An assumption is that it is unknown in advance whether the MN, the SN, or both the MN and SN will carry the application session, so it is unclear how to satisfy the Requirements 1 and 2 described above.

In some embodiments, despite this uncertainty, the RAN (the MN, the SN or both) still assembles either two RVQoE configurations (one per node) or one merged configuration (to which both the MN and the SN have contributed) and sends the merged configuration(s) to the UE.

In some embodiments, the RAN waits to configure the UE until it determines which node(s) carry the session. Alternatively, the RAN may configure the UE with the application layer measurements, but later perform a reconfiguration accounting for which node carries the session. This has the advantage that support for reconfiguring QoE/RVQoE configurations at the application layer during an ongoing application layer session may not be needed, because the information regarding which node the reports should be sent to may only impact the UE access stratum (AS) layer and reconfiguring the UE AS layer can be done at any time.

Some embodiments include determining whether both the MN and the SN carry the application session or whether both the MN and SN can carry the application session. Note that some methods herein apply both to the scenarios where the session is carried via both nodes and for the scenario where the session is carried by only one of the two nodes.

The session may be carried via both RAN nodes if the measurement session is mapped to more than one data radio bearer (DRB). Alternatively, the measurement session may be mapped to one DRB and the DRB is configured as a split bearer where the data is sent to/from both the MN and the SN. Or alternatively, the DRB may be configured as a duplicated bearer where both the MN and the SN carry the same data to/from the UE.

To be able to fulfill Requirements 1 and 2, it needs to be determined which node(s) carry the session. In some embodiments, determining which nodes carry the session may be determined after the session starts, the measurements have been configured and the measurements have started.

In some embodiments, determining which nodes carry the session may be determined before the application session starts.

In some embodiments, determining which nodes carry the session may be determined after the session starts, but before the measurements are configured.

In some embodiments, determining which nodes carry the session may be determined after the session starts, after the application layer measurements have been configured, but before the reporting configuration has been configured.

In some embodiments, determining which nodes carry the session may be determined after the session starts, after the application layer measurements (and reporting) have been configured, but before the first RVQoE report has been sent, thereby giving the network time to reconfigure the RVQoE reporting to go to the desired node(s) (unless this was already correctly configured) before the first RVQoE report is sent and thereby all RVQoE reports (even the first one) will be sent to the desired node(s).

In some embodiments, determining which nodes carry the session may be determined at session start, after the RVQoE configuration is sent to the UE and before the first RVQoE containing RVQoE measurements arrives at the RAN node.

In some embodiments, determining which nodes carry the session may be determined by means of a communication/coordination between different functions/entities of a certain RAN node, wherein one of the entity/function receives user plane data, and another entity/function receives control plane data.

In some embodiments, determining which nodes carry the session is determined before the session start or during the transfer of data for a session, based on service type and/or configuration parameters sent to the RAN node.

In some embodiments, determining which nodes carry the session may be determined after the session starts, the measurements have been configured, started, and the first RVQoE report/reports is/are transmitted to the respective nodes (each node which generated RVQoE configuration) to subsequently/after immediate RVQoE report analysis, optimize how the application session should be delivered (via two nodes or only one node) and adjust RVQoE configuration(s) and reporting conditions.

In some embodiments, determining which nodes carry the session may be done periodically/iteratively, given that the session is ongoing, and after the RVQoE report reception (after each report or less often, or after the event triggering the reporting happens for event-triggered RVQoE reporting), because the SN may be periodically activated/deactivated by the network, and thus how the session is carried, i.e., via one node or two nodes, may vary in time.

The determination of whether both nodes carry the session may be achieved according to the following methods.

The application may indicate (via the UE AS) together with the session start indication, which network socket parameters it uses (e.g., transport layer protocol (e.g., Transmission Control Protocol (TCP), Stream Control Transmission Protocol (SCTP), Real Time Protocol (RTP)), and transport layer protocol source and destination port numbers, and potentially also source and/or destination Internet protocol (IP) address(es)) and then the RAN determines which DRB maps to the data flow to DRB mapping configuration/filters. Alternatively, the UE AS translates the socket parameters to DRB ID(s) (based on data flow to DRB mapping configuration/filters) and sends the DRB ID(s) together with the session start indication to the RAN.

With this approach, the session has already started when the network gets a chance to react, but assuming that there is some time until the first RVQoE report is sent, the network may be able to handle even the first RVQoE report correctly by, if needed, reconfiguring the RVQoE reporting mechanisms (e.g., via RVQoE (re)configuration and/or signaling radio bearer SRB) (re)configuration) before the first RVQoE report is sent.

A variant is that the application sends an initial RVQoE report immediately upon session start, including the network socket parameters (possibly translated to DRB ID(s) by the UE AS).

Yet another variant is that the application, in response to receiving the RVQoE configuration, returns the socket parameters, which the UE AS forwards to the network (e.g., in a MeasurementReportAppLayer RRC message or anew RRC message), or translates to DRB ID(s) which it sends to the network. Upon receiving this information in response to sending the RVQoE configuration to the UE, if the information comes in the form of network socket parameters, the RAN can determine, based on the configured data flow to DRB mapping filters, which DRB(s) the application's data flow(s) will be carried on during subsequent application sessions. When the RAN has identified the concerned DRB(s), either derived by the RAN itself from the socket parameters or received explicitly from the UE AS, if deemed needed or desired, the RAN may reconfigure the RVQoE reporting mechanisms (e.g., via RVQoE (re)configuration and/or SRB (re)configuration). When a session subsequently starts for the concerned application, and the configured RVQoE measurements start accordingly, the RVQoE reports will be sent to the desired node(s) in accordance with the RVQoE configuration and/or SRB configuration. Note that this method does not depend on a session start indication being sent when the application session and the associated QoE/RVQoE measurement session starts. Such a session start indication may or may not be sent (as configured in the AppLayerMeasConfig-r17 IE sent to the UE).

This method implies that the network is prepared before a session even starts (unless it was already ongoing when the RVQoE configuration was sent to the UE), and consequently the RAN can ensure that the RVQoE reports will be sent to the desired node(s) during subsequent application sessions.

In one option, the network uses this information to reconfigure the UE with information to which node(s) the reports shall be sent.

Yet another way is that the network is configured with transport protocol port numbers various applications are known to use. This can be a preconfigured table of applications (e.g. represented by service types and/or application identifiers) and associated transport layer protocol port numbers. Alternatively, or as a complement (possibly complementing or overriding information in a preconfigured table) the OAM system can send this information (i.e., the transport layer protocol port numbers the application is expected to use) together with the QoE configuration directly to the RAN or via the core network.

Yet another way is that the RAN nodes inspect the packet headers of the data flows they carry to see which socket/header parameters—in particular the transport protocol port numbers—that are used in the data flows. By comparing this with previously obtained information about the applications' usage of socket parameters—in particular transport protocol port numbers—the RAN can this way identify which DRBs and/or which DC connectivity leg(s) that carries/carry the application session data flow(s). Any of the previously mentioned ways that the RAN can obtain information about the applications' usage of socket parameters may be used together with this method (e.g., information sent from the application in the UE, or preconfigured application/service type to port number mapping, or information about port numbers conveyed from the OAM system together with the QoE configuration).

In some embodiments, the RVQoE configuration that a RAN node sends to a UE may contain a DRB ID or a list of DRB IDs that the RAN node will assign to the UE AS for sending/receiving to/from the UE data pertaining to a session for an application of a certain service type or data pertaining to a session for an application mapped to a certain 5G QoS indicator (5QI) or to a certain QoS flow identifier. To aid the UE AS to identify that a data flow originates or terminates in a certain application (or an application of a certain service type), the application may inform the UE AS of the network socket parameters of a data flow about to be started or a newly started data flow.

In some embodiments, the RAN node may request a UE, as part of the RVQoE configuration, to send a first “dummy” RVQoE report (i.e., not containing actual RVQoE measurements), at the time of session start (i.e. in case of periodic reporting of RVQoE measurements, before the first reporting period is elapsed), to be used by the RAN node to determine whether itself is used to carry the session. Upon receiving this instruction in the RVQoE configuration, and upon the start (or the resume) of a session for an application, the UE application layer will send a dummy RVQoE report containing only the session start indication, and/or containing another indication which is meant to assist the RAN node in the determination of whether it is carrying data for a session for an application. The UE AS may complement this RVQoE report with an indication of the DRB IDs setup and to be used for used for sending/receiving data of the just-started session for the application.

In another variant, one realization to make the RAN node(s) aware of the type of traffic that they are carrying, e.g., video, audio, is to exchange information between the user plane and the control plane about how the traffic is split between the legs. The above may be communicated by the user plane function which may determine the mapping of different flows within an application to different nodes based on the available capacity, capability, etc., based on deep packet inspection, or with explicit information on socket parameters. For a RAN node in split architecture (e.g., a gNB realized as gNB-CU-CP, one or more gNB-CU-UPs, and one or more gNB-DUs), the gNB-CU-CP (the one at the MN, but it could be also at the SN), configures a UE for RVQoE measurements and sends an indication to the gNB-CU-UP (or one of the gNB-CU-UPs) of the same RAN node, to inform the gNB-CU-UP that a RVQoE configuration has been sent to the UE or is about to be sent to the UE. The idea is to let the gNB-CU-CP become aware of the fact that the RAN node it belongs to is a RAN node that carries the session, via the gNB-CU-UP. After the indication concerning the fact that UE is configured for RVQoE has arrived at the gNB-CU-UP, the gNB-CU-UP, upon reception of data carried over a DRB for that UE, it can inform the gNB-CU-CP that it is RAN node to which both the gNB-CU-CP and gNB-CU-UP belong to, that carries a session for an application for the UE. The gNB-CU-CP of the RAN node in question (e.g. the MN) notifies via XnAP the other RAN node comprised in NR-DC operation that the sender RAN node (itself) is involved in the transfer of data for a session of an application for the UE. The receiving RAN node goes through the same process just described. By exchanging this mutual information, each RAN node becomes aware of whether both MN and SN are used to carry the session of the application for the UE, or whether it is only one of the MN or the SN that are used to carry the session of the application for the UE.

The process as describe can rely on the methods previously described (e.g., using the socket or header parameters).

In some embodiments, the gNB-CU-UP may be replaced by a gNB-DU (or one of the gNB-DUs served by the gNB-CU-CP in the RAN node).

In some embodiments, one RAN node may determine, based on QoE/RVQoE configuration parameters such as the service type and optionally based on other configuration parameters received by OAM, that it will carry all the sessions for an application pertaining to that service type, or that it can carry sessions for an application pertaining to that service type, or that it cannot carry sessions for an application pertaining to that service type, or that sessions for an application pertaining to that service type will be carried by another RAN node (e.g., the SN determines that it will be the MN to carry data for that application). An example is the service type “MTSI” for which an MN node determines/is configured so that all the sessions for an application pertaining to service type=MTSI will be carried by itself, or that, instead, they will be carried by the SN node.

In another option, a RAN node, before or during the transmission/reception of data for a session of an application pertaining to a certain service type, may determine that it can no longer carry the data for that service type (or for session of an application pertaining to a certain service type) and informs the other RAN node about it. This can happen, e.g., when configuration parameters are sent to the RAN node (e.g., from OAM) which alter the current way of handling the sessions for an application of a certain service type.

In another option, the network determines which node that carries the session and uses this information to indicate to the UE which nodes to send the reports to. The UE may be configured with this information after the RVQoE measurements have been configured, as the reporting configuration may only reside in RRC, whereas the measurements take place in the application layer.

In another option, the network may indicate which node the session should use depending on the coverage situation, and might indicate to the UE which nodes to send the reports to under different measured reference signal conditions.

In another option, the network can specify that reports pertaining to periodic reporting may be sent to one node, while the reports pertaining to event-triggered reporting are sent to the other node.

In situations where any of the above coordination or obtaining further information about which of the legs are carrying information, it should be assumed by default that both the SCG and the MCG nodes carry the application session as soon as the SCG has been activated.

Some embodiments include RAN actions upon determining which node(s) carry the session. When one of the RAN nodes learns (according to the methods described above or in some other way) that the session is carried or is to be carried by both nodes, or that it can potentially be carried by both nodes, the RAN node may perform actions based on the learning.

The RAN node (the MN, the SN, one of them after coordination with the other) may decide to avoid the session being carried by both nodes. There may be several motives for this, one of them being that it is difficult to distinguish which part of RVQoE report pertains to which node (because the report is generated at the UE application layer and it refers to all the legs carrying the session) and avoiding additional resource allocation at a second node to carry a small amount of traffic.

If the “leaming” happened after the measurement starts, the RAN node may take actions to prevent the session being carried over both nodes, e.g., to reconfigure the DRBs so that all DRBs used for the session are carried over the same node.

Otherwise, if it is acceptable that the session is carried via both nodes, the RAN node (MN or SN) either:
Merges the RVQoE configuration generated by the MN with the one generated by the SN.
Sends the two RVQoE configurations to the UE, and instructs the UE to merge them and perform RVQoE measurements according to the merged configuration.
Sends the two RVQoE configurations to the UE, and the corresponding nodes configure the UE with the respective configurations. In this case, the RVQoE measurement reports are sent to the respective nodes, if the SRBs required by each node to accept the transmitted reports, are configured for reporting.

The RAN may reconfigure the RVQoE reporting mechanisms (e.g. involving (re)configuration of the RVQoE configuration or (re)configuring SRB(s) for RVQoE reporting), to make the RVQoE reports end up in the desired node(s). When both nodes are involved in carrying the session, this may mean that both nodes should receive the RVQoE reports, either directly from the UE (i.e. the UE duplicates the RVQoE reports and sends one copy to the MN and one copy to the SN) or using reporting to one of the nodes (e.g. the MN) which forwards a copy of the RVQoE report to the other node (e.g. the SN).

Some embodiments include RVQoE measurement reporting when both nodes carry or are bound to carry the session. If the session is to be carried via both RAN nodes, e.g. if the session is mapped to more than one DRB, and unless the RAN node prevents it by reconfiguration, the UE should be instructed whether to deliver the RVQoE reports to both or only one of the nodes, which will then forward the report to the other node. In some cases, duplication is used to carry the data for the session to the UE, where both the MN and the SN carry the same data to the UE. In some cases, a split bearer is used where both the MN and the SN carry data for the same DRB, but some data is carried via the MN and some data is carried via the SN. In all these cases involving both RAN nodes, the UE can be instructed (implicitly or explicitly) to send the QoE reports and/or RVQoE reports towards both nodes, or, to only one of them.

The instruction may be sent together with the RVQoE configuration. The instruction may be sent as a reconfiguration of a previously configured RVQoE configuration. The instruction may be sent implicitly in relation to the SRBs configured for the UE. The instruction may involve any combination of the above, and in addition to that, configuration or reconfiguration of SRB(s) for RVQoE reporting (e.g. SRB4, SRB3 and/or SRB5).

In some scenarios, bearer reconfiguration results in that the session previously carried by one of the RAN nodes is from now on carried by both RAN nodes. In that case, the UE can be explicitly or implicitly instructed where to send the reports, e.g.:
Send, from now on, the reports to the SN, or to MN.
Continue to report to the node that so far received the reports, e.g., the MN, or the SN.
Send, from now on, the reports to both the MN and the SN

There may be a case that both nodes, the MN and SN, can configure a UE for the RVQoE measurements, however, the SN does not support the SRB5 (or any other SRB specified to carry the RVQoE reports from the UE to the SN). Therefore, the reports pertaining to both MN and SN generated RVQoE configurations, are sent to the MN. In this case, the indications related to which node which configuration/report originated from, should be included in the RVQoE report. This may be used if the MN would want to, or be asked by the SN, to forward the SN QoE configuration associated reports.

Some embodiments include distinguishing which part of the RVQoE report pertains to which node. Another problem comes from the fact that the UE application layer generates the RVQoE reports and that each report pertains to the entire data flow of the session (rather than, e.g., only one of the bearers), if the session is carried by both nodes, it is unclear which part of the RVQoE report is relevant for which of the two RAN nodes serving the UE.

In general, if both RAN nodes carry the session, some data flows constituting the session are carried over one RAN node, and some flows via the other node. For example, assuming that the session consists of data flow 1 (e.g., video for a streaming session) carried by one RAN node, and data flow 2 (e.g., audio for a streaming session) carried by the other RAN node (this can be generalized to an arbitrary number of data flows constituting an application session). In this case, the reporting can be organized as follows: send the reports pertaining to data flow 1 to the RAN node carrying the data flow 1, the reports pertaining to data flow 2 to the RAN node carrying the data flow 2, or send reports for both data flows to one of the RAN nodes.

In the case where a clear split between the traffic carried by each of the nodes and how this traffic maps to the application is not possible, either due to the application (where multiple component streams are fetched without a clear separation within a container), or due to the user plane function not being able to map different sub flows to different nodes on a one-to-one basis, e.g., with a split bearer, the RAN in this case does not benefit by configuring customized RVQoE reports (i.e., on MN or SN separately for different data streams that it may carry), or even directing the UE to report RVQoE corresponding to specific data flows to one RAN node.

In the above cases, the RAN can only configure reporting of RVQoE (which shall comprise of all components of the application) to one or both the nodes. While both nodes can participate in the configuration, the reports are not specific to one node.

When the RVQoE reports cannot be individually tailored to the different nodes based on the traffic a node may carry, a single RVQoE report (or a report mirrored to both MN and SN) indicating the overall QoE of a session shall be used.

When the application session data flow(s) is(are) carried over a split DRB (or multiple split DRBs), and consequently traverse both DC connectivity legs, a result is that neither the MN nor the SN can independently control adaptations of the treatment of the application session data flow(s), such as scheduling priority adaptations. This implies that coordination between the MN and the SN to optimize the adaptations triggered by the RVQoE reports would be beneficial.

One method of coordination is that the MN determines which of the MN and the SN that should adapt its treatment of the application session data flow (e.g. the treatment of the concerned DRB(s)), and optionally in what way the treatment should be adapted. The MN can instruct the SN accordingly, if the MN decides that the SN should perform adaptations. If the MN decides to perform all adaptations itself, it does optionally not have to inform the SN.

In a variant of the above method, the MN sets targets for the adaptation (at least sets one or more target(s) for the SN's adaptation, e.g. that the transmission resources allocated (through scheduling) to the concerned application session data flow(s) (e.g. to the concerned DRB(s)) should be increased, or decreased, by a certain percentage. Another type of adaptation target could be a target related to how long of time the SN can wait until it reacts to a scheduling request from the UE, and/or how long of time the SN can wait until it reacts to a buffer status report from the UE wherein the logical channel group of the concerned DRB(s) is included in the buffer status report.

Further coordination actions between the MN and the SN may aim to ensure that: the change in QoS parameters (or the action performed as a result of the RVQoE report) is proportional to the volume of data carried over each of the nodes, or the two nodes communicate on a net change in QoS parameters, such as prioritization, allocated uplink/downlink budget, etc., and this change is split between the two nodes depending on the available capacity in each of the nodes.

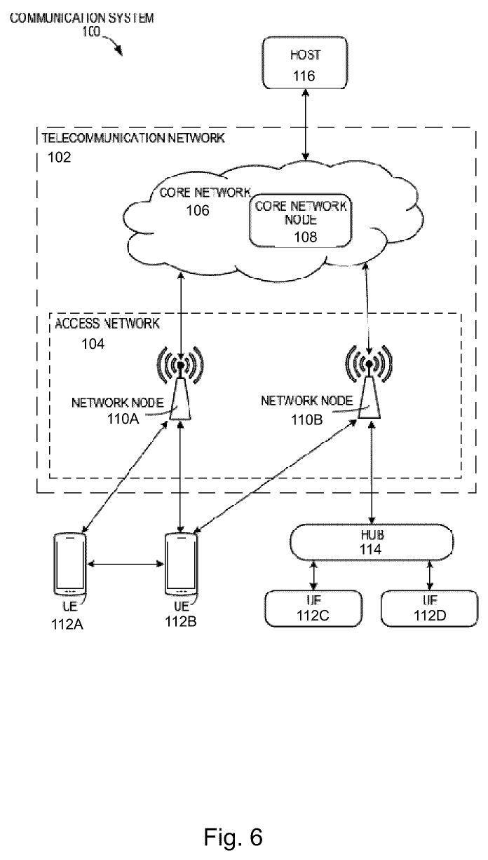

FIG. 6 illustrates an example of a communication system 100 in accordance with some embodiments. In the example, the communication system 100 includes a telecommunication network 102 that includes an access network 104, such as a radio access network (RAN), and a core network 106, which includes one or more core network nodes 108. The access network 104 includes one or more access network nodes, such as network nodes 110a and 110b (one or more of which may be generally referred to as network nodes 110), or any other similar 3rd Generation Partnership Project (3GPP) access node or non-3GPP access point. The network nodes 110 facilitate direct or indirect connection of user equipment (UE), such as by connecting UEs 112a, 112b, 112c, and 112d (one or more of which may be generally referred to as UEs 112) to the core network 106 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system 100 may include any number of wired or wireless networks, network nodes, UEs, and/or any other components or systems that may facilitate or participate in the communication of data and/or signals whether via wired or wireless connections. The communication system 100 may include and/or interface with any type of communication, telecommunication, data, cellular, radio network, and/or other similar type of system.

The UEs 112 may be any of a wide variety of communication devices, including wireless devices arranged, configured, and/or operable to communicate wirelessly with the network nodes 110 and other communication devices. Similarly, the network nodes 110 are arranged, capable, configured, and/or operable to communicate directly or indirectly with the UEs 112 and/or with other network nodes or equipment in the telecommunication network 102 to enable and/or provide network access, such as wireless network access, and/or to perform other functions, such as administration in the telecommunication network 102.

In the depicted example, the core network 106 connects the network nodes 110 to one or more hosts, such as host 116. These connections may be direct or indirect via one or more intermediary networks or devices. In other examples, network nodes may be directly coupled to hosts. The core network 106 includes one more core network nodes (e.g., core network node 108) that are structured with hardware and software components. Features of these components may be substantially similar to those described with respect to the UEs, network nodes, and/or hosts, such that the descriptions thereof are generally applicable to the corresponding components of the core network node 108. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF).

The host 116 may be under the ownership or control of a service provider other than an operator or provider of the access network 104 and/or the telecommunication network 102, and may be operated by the service provider or on behalf of the service provider. The host 116 may host a variety of applications to provide one or more services. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system 100 of FIG. 6 enables connectivity between the UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g., 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, the telecommunication network 102 is a cellular network that implements 3GPP standardized features. Accordingly, the telecommunications network 102 may support network slicing to provide different logical networks to different devices that are connected to the telecommunication network 102. For example, the telecommunications network 102 may provide Ultra Reliable Low Latency Communication (URLLC) services to some UEs, while providing Enhanced Mobile Broadband (eMBB) services to other UEs, and/or Massive Machine Type Communication (mMTC)/Massive IoT services to yet further UEs.

In some examples, the UEs 112 are configured to transmit and/or receive information without direct human interaction. For instance, a UE may be designed to transmit information to the access network 104 on a predetermined schedule, when triggered by an internal or external event, or in response to requests from the access network 104. Additionally, a UE may be configured for operating in single- or multi-RAT or multi-standard mode. For example, a UE may operate with any one or combination of Wi-Fi, NR (New Radio) and LTE, i.e. being configured for multi-radio dual connectivity (MR-DC), such as E-UTRAN (Evolved-UMTS Terrestrial Radio Access Network) New Radio—Dual Connectivity (EN-DC).

In the example, the hub 114 communicates with the access network 104 to facilitate indirect communication between one or more UEs (e.g., UE 112c and/or 112d) and network nodes (e.g., network node 110b). In some examples, the hub 114 may be a controller, router, content source and analytics, or any of the other communication devices described herein regarding UEs. For example, the hub 114 may be a broadband router enabling access to the core network 106 for the UEs. As another example, the hub 114 may be a controller that sends commands or instructions to one or more actuators in the UEs. Commands or instructions may be received from the UEs, network nodes 110, or by executable code, script, process, or other instructions in the hub 114. As another example, the hub 114 may be a data collector that acts as temporary storage for UE data and, in some embodiments, may perform analysis or other processing of the data. As another example, the hub 114 may be a content source. For example, for a UE that is a VR headset, display, loudspeaker or other media delivery device, the hub 114 may retrieve VR assets, video, audio, or other media or data related to sensory information via a network node, which the hub 114 then provides to the UE either directly, after performing local processing, and/or after adding additional local content. In still another example, the hub 114 acts as a proxy server or orchestrator for the UEs, in particular if one or more of the UEs are low energy IoT devices.

The hub 114 may have a constant/persistent or intermittent connection to the network node 110b. The hub 114 may also allow for a different communication scheme and/or schedule between the hub 114 and UEs (e.g., UE 112c and/or 112d), and between the hub 114 and the core network 106. In other examples, the hub 114 is connected to the core network 106 and/or one or more UEs via a wired connection. Moreover, the hub 114 may be configured to connect to an M2M service provider over the access network 104 and/or to another UE over a direct connection. In some scenarios, UEs may establish a wireless connection with the network nodes 110 while still connected via the hub 114 via a wired or wireless connection. In some embodiments, the hub 114 may be a dedicated hub—that is, a hub whose primary function is to route communications to/from the UEs from/to the network node 110b. In other embodiments, the hub 114 may be a non-dedicated hub—that is, a device which is capable of operating to route communications between the UEs and network node 110b, but which is additionally capable of operating as a communication start and/or end point for certain data channels.

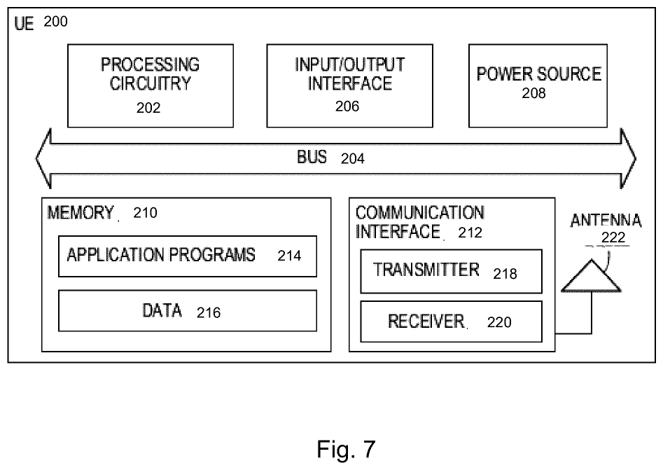

FIG. 7 shows a UE 200 in accordance with some embodiments. As used herein, a UE refers to a device capable, configured, arranged and/or operable to communicate wirelessly with network nodes and/or other UEs. Examples of a UE include, but are not limited to, a smart phone, mobile phone, cell phone, voice over IP (VoIP) phone, wireless local loop phone, desktop computer, personal digital assistant (PDA), wireless cameras, gaming console or device, music storage device, playback appliance, wearable terminal device, wireless endpoint, mobile station, tablet, laptop, laptop-embedded equipment (LEE), laptop-mounted equipment (LME), smart device, wireless customer-premise equipment (CPE), vehicle-mounted or vehicle embedded/integrated wireless device, etc. Other examples include any UE identified by the 3rd Generation Partnership Project (3GPP), including a narrow band internet of things (NB-IoT) UE, a machine type communication (MTC) UE, and/or an enhanced MTC (eMTC) UE.

A UE may support device-to-device (D2D) communication, for example by implementing a 3GPP standard for sidelink communication, Dedicated Short-Range Communication (DSRC), vehicle-to-vehicle (V2V), vehicle-to-infrastructure (V2I), or vehicle-to-everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

The UE 200 includes processing circuitry 202 that is operatively coupled via a bus 204 to an input/output interface 206, a power source 208, a memory 210, a communication interface 212, and/or any other component, or any combination thereof. Certain UEs may utilize all or a subset of the components shown in FIG. 7. The level of integration between the components may vary from one UE to another UE. Further, certain UEs may contain multiple instances of a component, such as multiple processors, memories, transceivers, transmitters, receivers, etc.

The processing circuitry 202 is configured to process instructions and data and may be configured to implement any sequential state machine operative to execute instructions stored as machine-readable computer programs in the memory 210. The processing circuitry 202 may be implemented as one or more hardware-implemented state machines (e.g., in discrete logic, field-programmable gate arrays (FPGAs), application specific integrated circuits (ASICs), etc.); programmable logic together with appropriate firmware; one or more stored computer programs, general-purpose processors, such as a microprocessor or digital signal processor (DSP), together with appropriate software; or any combination of the above. For example, the processing circuitry 202 may include multiple central processing units (CPUs).

In the example, the input/output interface 206 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into the UE 200. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, the power source 208 is structured as a battery or battery pack. Other types of power sources, such as an external power source (e.g., an electricity outlet), photovoltaic device, or power cell, may be used. The power source 208 may further include power circuitry for delivering power from the power source 208 itself, and/or an external power source, to the various parts of the UE 200 via input circuitry or an interface such as an electrical power cable. Delivering power may be, for example, for charging of the power source 208. Power circuitry may perform any formatting, converting, or other modification to the power from the power source 208 to make the power suitable for the respective components of the UE 200 to which power is supplied.

The memory 210 may be or be configured to include memory such as random access memory (RAM), read-only memory (ROM), programmable read-only memory (PROM), erasable programmable read-only memory (EPROM), electrically erasable programmable read-only memory (EEPROM), magnetic disks, optical disks, hard disks, removable cartridges, flash drives, and so forth. In one example, the memory 210 includes one or more application programs 214, such as an operating system, web browser application, a widget, gadget engine, or other application, and corresponding data 216. The memory 210 may store, for use by the UE 200, any of a variety of various operating systems or combinations of operating systems.

The memory 210 may be configured to include a number of physical drive units, such as redundant array of independent disks (RAID), flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as tamper resistant module in the form of a universal integrated circuit card (UICC) including one or more subscriber identity modules (SIMs), such as a USIM and/or ISIM, other memory, or any combination thereof. The UICC may for example be an embedded UICC (eUICC), integrated UICC (iUICC) or a removable UICC commonly known as ‘SIM card.’ The memory 210 may allow the UE 200 to access instructions, application programs and the like, stored on transitory or non-transitory memory media, to off-load data, or to upload data. An article of manufacture, such as one utilizing a communication system may be tangibly embodied as or in the memory 210, which may be or comprise a device-readable storage medium.

The processing circuitry 202 may be configured to communicate with an access network or other network using the communication interface 212. The communication interface 212 may comprise one or more communication subsystems and may include or be communicatively coupled to an antenna 222. The communication interface 212 may include one or more transceivers used to communicate, such as by communicating with one or more remote transceivers of another device capable of wireless communication (e.g., another UE or a network node in an access network). Each transceiver may include a transmitter 218 and/or a receiver 220 appropriate to provide network communications (e.g., optical, electrical, frequency allocations, and so forth). Moreover, the transmitter 218 and receiver 220 may be coupled to one or more antennas (e.g., antenna 222) and may share circuit components, software or firmware, or alternatively be implemented separately.

In the illustrated embodiment, communication functions of the communication interface 212 may include cellular communication, Wi-Fi communication, LPWAN communication, data communication, voice communication, multimedia communication, short-range communications such as Bluetooth, near-field communication, location-based communication such as the use of the global positioning system (GPS) to determine a location, another like communication function, or any combination thereof. Communications may be implemented in according to one or more communication protocols and/or standards, such as IEEE 802.11, Code Division Multiplexing Access (CDMA), Wideband Code Division Multiple Access (WCDMA), GSM, LTE, New Radio (NR), UMTS, WiMax, Ethernet, transmission control protocol/internet protocol (TCP/IP), synchronous optical networking (SONET), Asynchronous Transfer Mode (ATM), QUIC, Hypertext Transfer Protocol (HTTP), and so forth.

Regardless of the type of sensor, a UE may provide an output of data captured by its sensors, through its communication interface 212, via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., when moisture is detected an alert is sent), in response to a request (e.g., a user initiated request), or a continuous stream (e.g., a live video feed of a patient).

As another example, a UE comprises an actuator, a motor, or a switch, related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or to a robotic arm performing a medical procedure according to the received input.

A UE, when in the form of an Internet of Things (IoT) device, may be a device for use in one or more application domains, these domains comprising, but not limited to, city wearable technology, extended industrial application and healthcare. Non-limiting examples of such an IoT device are a device which is or which is embedded in: a connected refrigerator or freezer, a TV, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or Virtual Reality (VR), a wearable for tactile augmentation or sensory enhancement, a water sprinkler, an animal- or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence of the intended application of the IoT device in addition to other components as described in relation to the UE 200 shown in FIG. 7.

As yet another specific example, in an IoT scenario, a UE may represent a machine or other device that performs monitoring and/or measurements, and transmits the results of such monitoring and/or measurements to another UE and/or a network node. The UE may in this case be an M2M device, which may in a 3GPP context be referred to as an MTC device. As one particular example, the UE may implement the 3GPP NB-IoT standard. In other scenarios, a UE may represent a vehicle, such as a car, a bus, a truck, a ship and an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g. by controlling an actuator) to increase or decrease the drone's speed. The first and/or the second UE can also include more than one of the functionalities described above. For example, a UE might comprise the sensor and the actuator, and handle communication of data for both the speed sensor and the actuators.

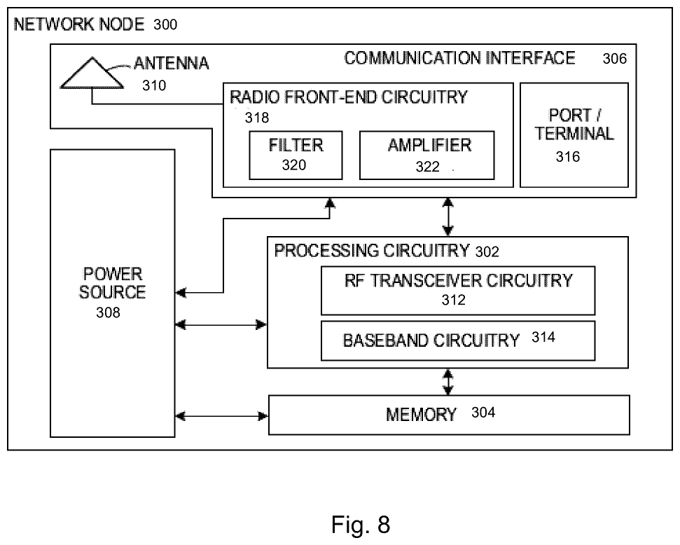

FIG. 8 shows a network node 300 in accordance with some embodiments. As used herein, network node refers to equipment capable, configured, arranged and/or operable to communicate directly or indirectly with a UE and/or with other network nodes or equipment, in a telecommunication network. Examples of network nodes include, but are not limited to, access points (APs) (e.g., radio access points), base stations (BSs) (e.g., radio base stations, Node Bs, evolved Node Bs (eNBs) and NR NodeBs (gNBs)).

Base stations may be categorized based on the amount of coverage they provide (or, stated differently, their transmit power level) and so, depending on the provided amount of coverage, may be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS).

Other examples of network nodes include multiple transmission point (multi-TRP) 5G access nodes, multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

The network node 300 includes a processing circuitry 302, a memory 304, a communication interface 306, and a power source 308. The network node 300 may be composed of multiple physically separate components (e.g., a NodeB component and a RNC component, or a BTS component and a BSC component, etc.), which may each have their own respective components. In certain scenarios in which the network node 300 comprises multiple separate components (e.g., BTS and BSC components), one or more of the separate components may be shared among several network nodes. For example, a single RNC may control multiple NodeBs. In such a scenario, each unique NodeB and RNC pair, may in some instances be considered a single separate network node. In some embodiments, the network node 300 may be configured to support multiple radio access technologies (RATs). In such embodiments, some components may be duplicated (e.g., separate memory 304 for different RATs) and some components may be reused (e.g., a same antenna 310 may be shared by different RATs). The network node 300 may also include multiple sets of the various illustrated components for different wireless technologies integrated into network node 300, for example GSM, WCDMA, LTE, NR, WiFi, Zigbee, Z-wave, LoRaWAN, Radio Frequency Identification (RFID) or Bluetooth wireless technologies. These wireless technologies may be integrated into the same or different chip or set of chips and other components within network node 300.

The processing circuitry 302 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 300 components, such as the memory 304, to provide network node 300 functionality.

In some embodiments, the processing circuitry 302 includes a system on a chip (SOC). In some embodiments, the processing circuitry 302 includes one or more of radio frequency (RF) transceiver circuitry 312 and baseband processing circuitry 314. In some embodiments, the radio frequency (RF) transceiver circuitry 312 and the baseband processing circuitry 314 may be on separate chips (or sets of chips), boards, or units, such as radio units and digital units. In alternative embodiments, part or all of RF transceiver circuitry 312 and baseband processing circuitry 314 may be on the same chip or set of chips, boards, or units.

The memory 304 may comprise any form of volatile or non-volatile computer-readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device-readable and/or computer-executable memory devices that store information, data, and/or instructions that may be used by the processing circuitry 302. The memory 304 may store any suitable instructions, data, or information, including a computer program, software, an application including one or more of logic, rules, code, tables, and/or other instructions capable of being executed by the processing circuitry 302 and utilized by the network node 300. The memory 304 may be used to store any calculations made by the processing circuitry 302 and/or any data received via the communication interface 306. In some embodiments, the processing circuitry 302 and memory 304 is integrated.

The communication interface 306 is used in wired or wireless communication of signaling and/or data between a network node, access network, and/or UE. As illustrated, the communication interface 306 comprises port(s)/terminal(s) 316 to send and receive data, for example to and from a network over a wired connection. The communication interface 306 also includes radio front-end circuitry 318 that may be coupled to, or in certain embodiments a part of, the antenna 310. Radio front-end circuitry 318 comprises filters 320 and amplifiers 322. The radio front-end circuitry 318 may be connected to an antenna 310 and processing circuitry 302. The radio front-end circuitry may be configured to condition signals communicated between antenna 310 and processing circuitry 302. The radio front-end circuitry 318 may receive digital data that is to be sent out to other network nodes or UEs via a wireless connection. The radio front-end circuitry 318 may convert the digital data into a radio signal having the appropriate channel and bandwidth parameters using a combination of filters 320 and/or amplifiers 322. The radio signal may then be transmitted via the antenna 310. Similarly, when receiving data, the antenna 310 may collect radio signals which are then converted into digital data by the radio front-end circuitry 318. The digital data may be passed to the processing circuitry 302. In other embodiments, the communication interface may comprise different components and/or different combinations of components.

In certain alternative embodiments, the network node 300 does not include separate radio front-end circuitry 318, instead, the processing circuitry 302 includes radio front-end circuitry and is connected to the antenna 310. Similarly, in some embodiments, all or some of the RF transceiver circuitry 312 is part of the communication interface 306. In still other embodiments, the communication interface 306 includes one or more ports or terminals 316, the radio front-end circuitry 318, and the RF transceiver circuitry 312, as part of a radio unit (not shown), and the communication interface 306 communicates with the baseband processing circuitry 314, which is part of a digital unit (not shown).

The antenna 310 may include one or more antennas, or antenna arrays, configured to send and/or receive wireless signals. The antenna 310 may be coupled to the radio front-end circuitry 318 and may be any type of antenna capable of transmitting and receiving data and/or signals wirelessly. In certain embodiments, the antenna 310 is separate from the network node 300 and connectable to the network node 300 through an interface or port.

The antenna 310, communication interface 306, and/or the processing circuitry 302 may be configured to perform any receiving operations and/or certain obtaining operations described herein as being performed by the network node. Any information, data and/or signals may be received from a UE, another network node and/or any other network equipment. Similarly, the antenna 310, the communication interface 306, and/or the processing circuitry 302 may be configured to perform any transmitting operations described herein as being performed by the network node. Any information, data and/or signals may be transmitted to a UE, another network node and/or any other network equipment.

The power source 308 provides power to the various components of network node 300 in a form suitable for the respective components (e.g., at a voltage and current level needed for each respective component). The power source 308 may further comprise, or be coupled to, power management circuitry to supply the components of the network node 300 with power for performing the functionality described herein. For example, the network node 300 may be connectable to an external power source (e.g., the power grid, an electricity outlet) via an input circuitry or interface such as an electrical cable, whereby the external power source supplies power to power circuitry of the power source 308. As a further example, the power source 308 may comprise a source of power in the form of a battery or battery pack which is connected to, or integrated in, power circuitry. The battery may provide backup power should the external power source fail.

Embodiments of the network node 300 may include additional components beyond those shown in FIG. 8 for providing certain aspects of the network node's functionality, including any of the functionality described herein and/or any functionality necessary to support the subject matter described herein. For example, the network node 300 may include user interface equipment to allow input of information into the network node 300 and to allow output of information from the network node 300. This may allow a user to perform diagnostic, maintenance, repair, and other administrative functions for the network node 300.

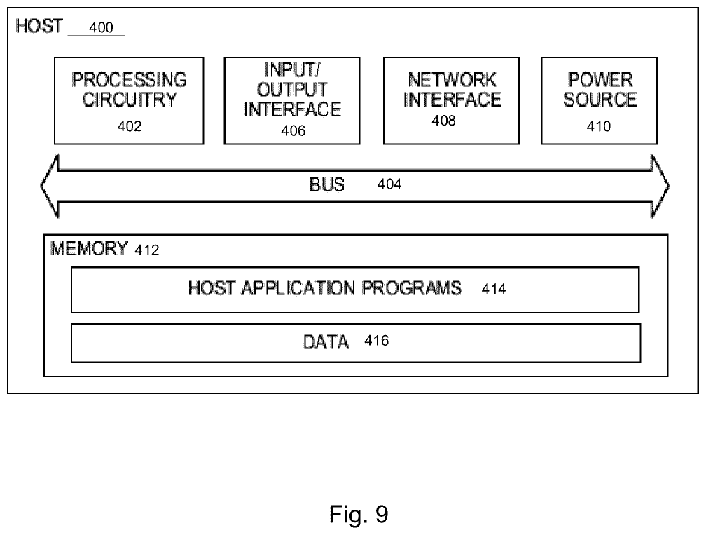

FIG. 9 is a block diagram of a host 400, which may be an embodiment of the host 116 of FIG. 6, in accordance with various aspects described herein. As used herein, the host 400 may be or comprise various combinations hardware and/or software, including a standalone server, a blade server, a cloud-implemented server, a distributed server, a virtual machine, container, or processing resources in a server farm. The host 400 may provide one or more services to one or more UEs.

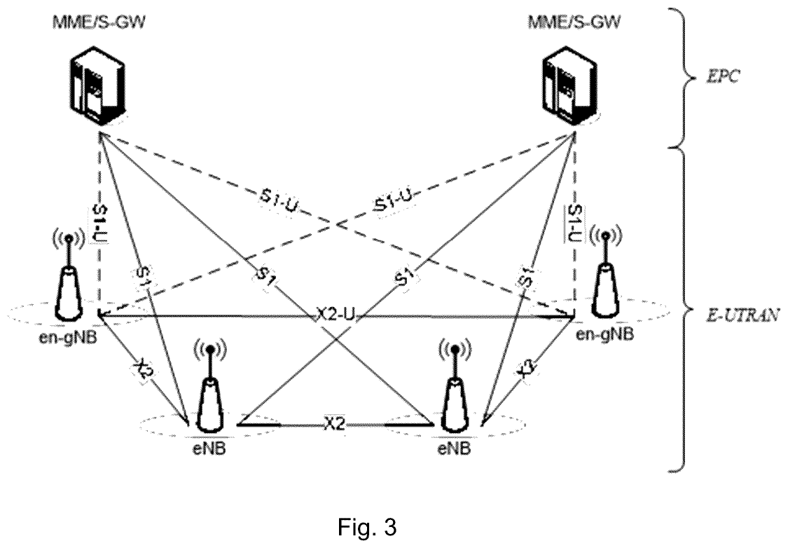

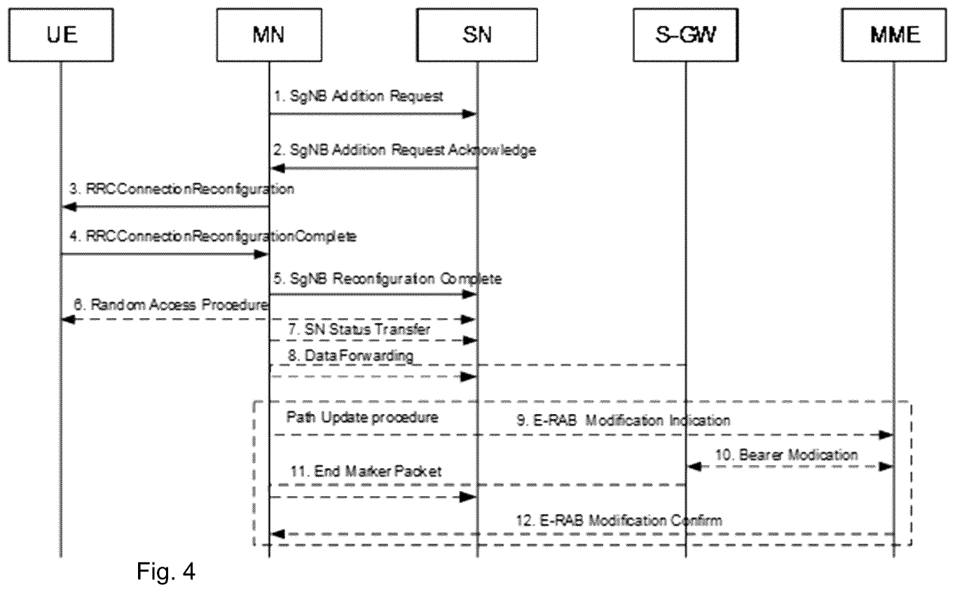

The host 400 includes processing circuitry 402 that is operatively coupled via a bus 404 to an input/output interface 406, a network interface 408, a power source 410, and a memory 412. Other components may be included in other embodiments. Features of these components may be substantially similar to those described with respect to the devices of previous figures, such as FIGS. 3 and 4, such that the descriptions thereof are generally applicable to the corresponding components of host 400.

The memory 412 may include one or more computer programs including one or more host application programs 414 and data 416, which may include user data, e.g., data generated by a UE for the host 400 or data generated by the host 400 for a UE. Embodiments of the host 400 may utilize only a subset or all of the components shown. The host application programs 414 may be implemented in a container-based architecture and may provide support for video codecs (e.g., Versatile Video Coding (VVC), High Efficiency Video Coding (HEVC), Advanced Video Coding (AVC), MPEG, VP9) and audio codecs (e.g., FLAC, Advanced Audio Coding (AAC), MPEG, G.711), including transcoding for multiple different classes, types, or implementations of UEs (e.g., handsets, desktop computers, wearable display systems, heads-up display systems). The host application programs 414 may also provide for user authentication and licensing checks and may periodically report health, routes, and content availability to a central node, such as a device in or on the edge of a core network. Accordingly, the host 400 may select and/or indicate a different host for over-the-top services for a UE. The host application programs 414 may support various protocols, such as the HTTP Live Streaming (HLS) protocol, Real-Time Messaging Protocol (RTMP), Real-Time Streaming Protocol (RTSP), Dynamic Adaptive Streaming over HTTP (MPEG-DASH), etc.

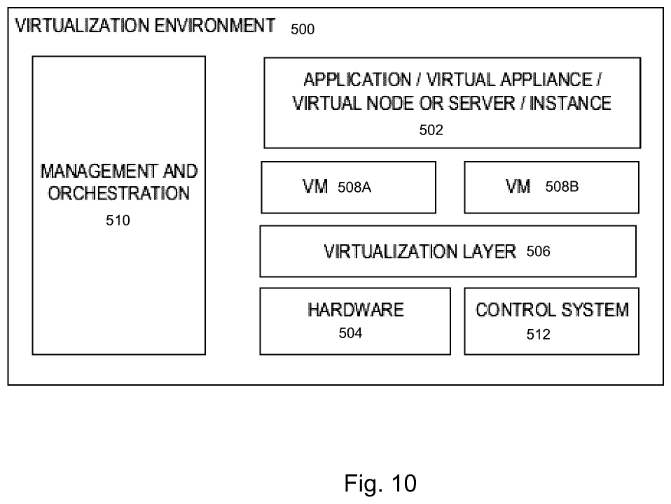

FIG. 10 is a block diagram illustrating a virtualization environment 500 in which functions implemented by some embodiments may be virtualized. In the present context, virtualizing means creating virtual versions of apparatuses or devices which may include virtualizing hardware platforms, storage devices and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more virtual machines (VMs) implemented in one or more virtual environments 500 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized.

Applications 502 (which may alternatively be called software instances, virtual appliances, network functions, virtual nodes, virtual network functions, etc.) are run in the virtualization environment Q400 to implement some of the features, functions, and/or benefits of some of the embodiments disclosed herein.

Hardware 504 includes processing circuitry, memory that stores software and/or instructions executable by hardware processing circuitry, and/or other hardware devices as described herein, such as a network interface, input/output interface, and so forth. Software may be executed by the processing circuitry to instantiate one or more virtualization layers 506 (also referred to as hypervisors or virtual machine monitors (VMMs)), provide VMs 508a and 508b (one or more of which may be generally referred to as VMs 508), and/or perform any of the functions, features and/or benefits described in relation with some embodiments described herein. The virtualization layer 506 may present a virtual operating platform that appears like networking hardware to the VMs 508.

The VMs 508 comprise virtual processing, virtual memory, virtual networking or interface and virtual storage, and may be run by a corresponding virtualization layer 506. Different embodiments of the instance of a virtual appliance 502 may be implemented on one or more of VMs 508, and the implementations may be made in different ways. Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, a VM 508 may be a software implementation of a physical machine that runs programs as if they were executing on a physical, non-virtualized machine. Each of the VMs 508, and that part of hardware 504 that executes that VM, be it hardware dedicated to that VM and/or hardware shared by that VM with others of the VMs, forms separate virtual network elements. Still in the context of NFV, a virtual network function is responsible for handling specific network functions that run in one or more VMs 508 on top of the hardware 504 and corresponds to the application 502.

Hardware 504 may be implemented in a standalone network node with generic or specific components. Hardware 504 may implement some functions via virtualization. Alternatively, hardware 504 may be part of a larger cluster of hardware (e.g. such as in a data center or CPE) where many hardware nodes work together and are managed via management and orchestration 510, which, among others, oversees lifecycle management of applications 502. In some embodiments, hardware 504 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a radio access node or a base station. In some embodiments, some signaling can be provided with the use of a control system 512 which may alternatively be used for communication between hardware nodes and radio units.

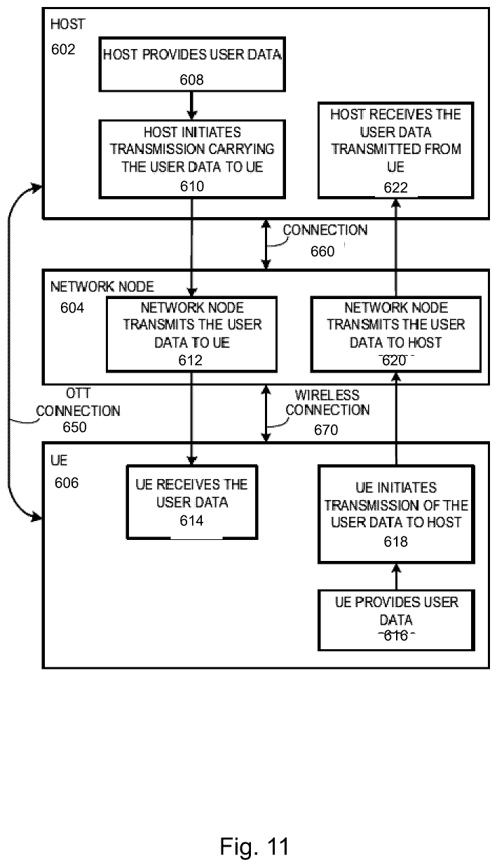

FIG. 11 shows a communication diagram of a host 602 communicating via a network node 604 with a UE 606 over a partially wireless connection in accordance with some embodiments. Example implementations, in accordance with various embodiments, of the UE (such as a UE 112a of FIG. 6 and/or UE 200 of FIG. 7), network node (such as network node 110a of FIG. 6 and/or network node 300 of FIG. 8), and host (such as host 116 of FIG. 6 and/or host 400 of FIG. 9) discussed in the preceding paragraphs will now be described with reference to FIG. 11.

Like host 400, embodiments of host 602 include hardware, such as a communication interface, processing circuitry, and memory. The host 602 also includes software, which is stored in or accessible by the host 602 and executable by the processing circuitry. The software includes a host application that may be operable to provide a service to a remote user, such as the UE 606 connecting via an over-the-top (OTT) connection 650 extending between the UE 606 and host 602. In providing the service to the remote user, a host application may provide user data which is transmitted using the OTT connection 650.

The network node 604 includes hardware enabling it to communicate with the host 602 and UE 606. The connection 660 may be direct or pass through a core network (like core network 106 of FIG. 6) and/or one or more other intermediate networks, such as one or more public, private, or hosted networks. For example, an intermediate network may be a backbone network or the Internet.

The UE 606 includes hardware and software, which is stored in or accessible by UE 606 and executable by the UE's processing circuitry. The software includes a client application, such as a web browser or operator-specific “app” that may be operable to provide a service to a human or non-human user via UE 606 with the support of the host 602. In the host 602, an executing host application may communicate with the executing client application via the OTT connection 650 terminating at the UE 606 and host 602. In providing the service to the user, the UE's client application may receive request data from the host's host application and provide user data in response to the request data. The OTT connection 650 may transfer both the request data and the user data. The UE's client application may interact with the user to generate the user data that it provides to the host application through the OTT connection 650.

The OTT connection 650 may extend via a connection 660 between the host 602 and the network node 604 and via a wireless connection 670 between the network node 604 and the UE 606 to provide the connection between the host 602 and the UE 606. The connection 660 and wireless connection 670, over which the OTT connection 650 may be provided, have been drawn abstractly to illustrate the communication between the host 602 and the UE 606 via the network node 604, without explicit reference to any intermediary devices and the precise routing of messages via these devices.

As an example of transmitting data via the OTT connection 650, in step 608, the host 602 provides user data, which may be performed by executing a host application. In some embodiments, the user data is associated with a particular human user interacting with the UE 606. In other embodiments, the user data is associated with a UE 606 that shares data with the host 602 without explicit human interaction. In step 610, the host 602 initiates a transmission carrying the user data towards the UE 606. The host 602 may initiate the transmission responsive to a request transmitted by the UE 606. The request may be caused by human interaction with the UE 606 or by operation of the client application executing on the UE 606. The transmission may pass via the network node 604, in accordance with the teachings of the embodiments described throughout this disclosure. Accordingly, in step 612, the network node 604 transmits to the UE 606 the user data that was carried in the transmission that the host 602 initiated, in accordance with the teachings of the embodiments described throughout this disclosure. In step 614, the UE 606 receives the user data carried in the transmission, which may be performed by a client application executed on the UE 606 associated with the host application executed by the host 602.

In some examples, the UE 606 executes a client application which provides user data to the host 602. The user data may be provided in reaction or response to the data received from the host 602. Accordingly, in step 616, the UE 606 may provide user data, which may be performed by executing the client application. In providing the user data, the client application may further consider user input received from the user via an input/output interface of the UE 606. Regardless of the specific manner in which the user data was provided, the UE 606 initiates, in step 618, transmission of the user data towards the host 602 via the network node 604. In step 620, in accordance with the teachings of the embodiments described throughout this disclosure, the network node 604 receives user data from the UE 606 and initiates transmission of the received user data towards the host 602. In step 622, the host 602 receives the user data carried in the transmission initiated by the UE 606.

One or more of the various embodiments improve the performance of OTT services provided to the UE 606 using the OTT connection 650, in which the wireless connection 670 forms the last segment. More precisely, the teachings of these embodiments may improve the delay to directly activate an SCell by RRC and power consumption of user equipment and thereby provide benefits such as reduced user waiting time and extended battery lifetime.

In an example scenario, factory status information may be collected and analyzed by the host 602. As another example, the host 602 may process audio and video data which may have been retrieved from a UE for use in creating maps. As another example, the host 602 may collect and analyze real-time data to assist in controlling vehicle congestion (e.g., controlling traffic lights). As another example, the host 602 may store surveillance video uploaded by a UE. As another example, the host 602 may store or control access to media content such as video, audio, VR or AR which it can broadcast, multicast or unicast to UEs. As other examples, the host 602 may be used for energy pricing, remote control of non-time critical electrical load to balance power generation needs, location services, presentation services (such as compiling diagrams etc. from data collected from remote devices), or any other function of collecting, retrieving, storing, analyzing and/or transmitting data.

In some examples, a measurement procedure may be provided for the purpose of monitoring data rate, latency and other factors on which the one or more embodiments improve. There may further be an optional network functionality for reconfiguring the OTT connection 650 between the host 602 and UE 606, in response to variations in the measurement results. The measurement procedure and/or the network functionality for reconfiguring the OTT connection may be implemented in software and hardware of the host 602 and/or UE 606. In some embodiments, sensors (not shown) may be deployed in or in association with other devices through which the OTT connection 650 passes; the sensors may participate in the measurement procedure by supplying values of the monitored quantities exemplified above, or supplying values of other physical quantities from which software may compute or estimate the monitored quantities. The reconfiguring of the OTT connection 650 may include message format, retransmission settings, preferred routing etc.; the reconfiguring need not directly alter the operation of the network node 604. Such procedures and functionalities may be known and practiced in the art. In certain embodiments, measurements may involve proprietary UE signaling that facilitates measurements of throughput, propagation times, latency and the like, by the host 602. The measurements may be implemented in that software causes messages to be transmitted, in particular empty or ‘dummy’ messages, using the OTT connection 650 while monitoring propagation times, errors, etc.

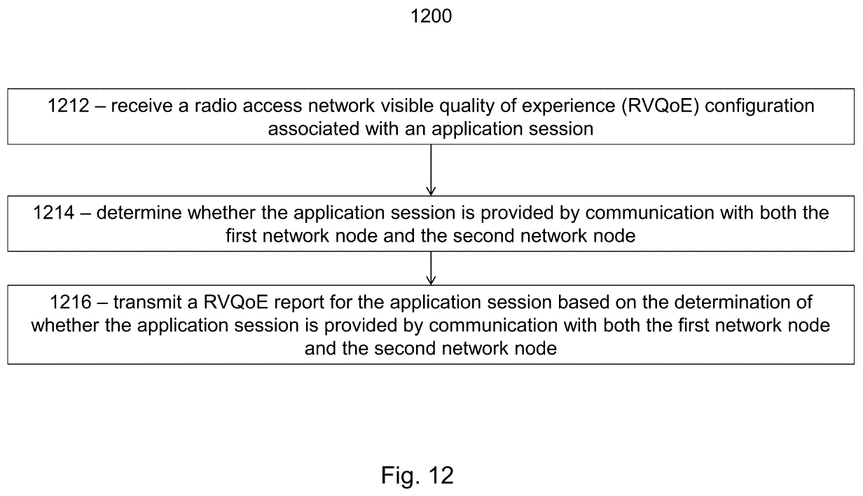

FIG. 12 is a flowchart illustrating an example method in a wireless device, according to certain embodiments. In particular embodiments, one or more steps of FIG. 12 may be performed by UE 200 described with respect to FIG. 7. The wireless device is operating in dual connectivity with a first network node and a second network node.

The method begins at step 1212, where the wireless device (e.g., UE 200) receives a RVQoE configuration associated with an application session. In particular embodiments, receiving the RVQoE configuration occurs after a start of the application session, and the RVQoE configuration comprises an indication of whether RVQoE reporting is towards the first network node, the second network node, or both the first and second network node based on protocols used by the application session.

In particular embodiments, receiving the RVQoE configuration occurs after a start of the application session, and after a first RVQoE report has been transmitted by the wireless device, and the RVQoE configuration comprises an indication of whether RVQoE reporting is towards the first network node, the second network node, or both the first and second network node based on the first RVQoE report.

In particular embodiments, the wireless device may receive a first RVQoE configuration before the start of the application session, and may receive an updated RVQoE configuration after the start of the application session.

Other and additional examples of receiving the RVQoE configuration are described with respect to the embodiments and examples described above.

At step 1214, the wireless device determines whether the application session is provided by communication with both the first network node and the second network node.

In particular embodiments, determining whether the application session is provided by communication with both the first network node and the second network node comprises receiving a reporting configuration in the RVQoE configuration indicating whether RVQoE reporting is towards the first network node, the second network node, or both the first and second network node.

In particular embodiments, determining whether the application session is provided by communication with both the first network node and the second network node is based on an association between the application session and one or more bearer channels.

Other and additional examples of determining whether the application session is provided by communication with both the first network node and the second network node are described with respect to the embodiments and examples described above.

At step 1216, the wireless device transmits a RVQoE report for the application session based on the determination of whether the application session is provided by communication with both the first network node and the second network node. For example, the wireless device may transmit the RVQoE report to only the first network node, only the second network node, or to both the first and second network nodes. In some embodiments, the wireless device may transmit the RVQoE report to one network node and that network node may forward the RVQoE report to another network node, e.g., the second network node.

Modifications, additions, or omissions may be made to method 1200 of FIG. 12. Additionally, one or more steps in the method of FIG. 12 may be performed in parallel or in any suitable order.

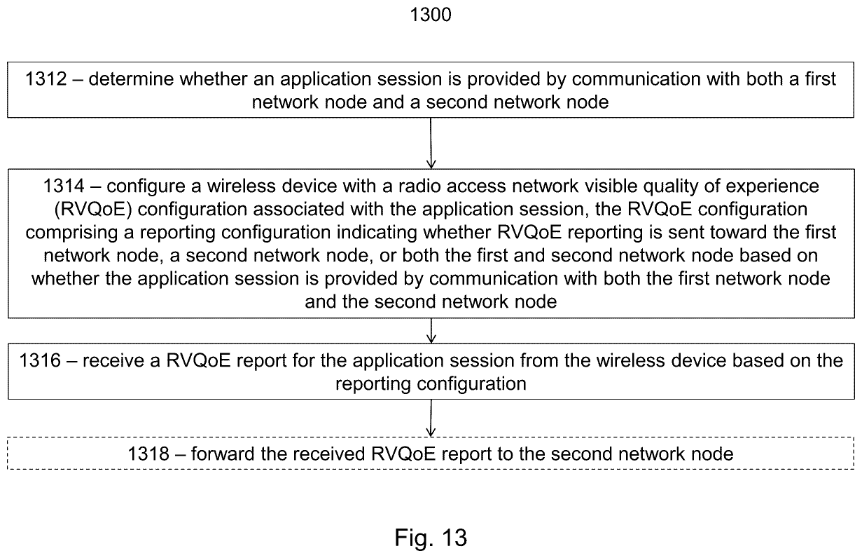

FIG. 13 is a flowchart illustrating an example method in a first network node, according to certain embodiments. In particular embodiments, one or more steps of FIG. 13 may be performed by network node 300 described with respect to FIG. 8. The first network node is operating in dual connectivity with a second network node.

The method begins at step 1312, where the first network node (e.g., network node 300) determines whether an application session is provided by communication with both the first network node and the second network node.

In particular embodiments, determining whether the application session is provided by communication with both the first network node and the second network node is based on an association between the application session and one or more bearer channels.

In particular embodiments, determining whether the application session is provided by communication with both the first network node and the second network node comprises receiving the association between the application session and one or more bearer channels from the wireless device.

In particular embodiments, determining whether the application session is provided by communication with both the first network node and the second network node is based on protocols used by the application session.

In particular embodiments, determining whether the application session is provided by communication with both the first network node and the second network node occurs after a first RVQoE report has been transmitted by the wireless device and the determination is based on the first RVQoE report.

In particular embodiments, the first network node comprises a MN and the second network node comprises a SN, or the first network node comprises a SN and the second network node comprises a MN.

Other and additional examples of determining whether the application session is provided by communication with both the first network node and the second network node are described with respect to the embodiments and examples described above.

At step 1314, the first network node configures a wireless device with a RVQoE configuration associated with the application session. The RVQoE configuration comprises a reporting configuration indicating whether RVQoE reporting is towards the first network node, the second network node, or both the first and second network node based on whether the application session is provided by communication with both the first network node and the second network node.

At step 1316, the first network node receives a RVQoE report for the application session from the wireless device based on the reporting configuration.

At step 1318, the first network node may forward the received RVQoE report to the second network node. For example, the wireless device may be configured to only send the RVQoE report to the first network node, but the first network node determines the second network node may also be interested in the RVQoE report and forwards the RVQoE report to the second network node.

Modifications, additions, or omissions may be made to method 1300 of FIG. 13. Additionally, one or more steps in the method of FIG. 13 may be performed in parallel or in any suitable order.

Modifications, additions, or omissions may be made to the methods disclosed herein without departing from the scope of the invention. The methods may include more, fewer, or other steps. Additionally, steps may be performed in any suitable order.

The foregoing description sets forth numerous specific details. It is understood, however, that embodiments may be practiced without these specific details. In other instances, well-known circuits, structures and techniques have not been shown in detail in order not to obscure the understanding of this description. Those of ordinary skill in the art, with the included descriptions, will be able to implement appropriate functionality without undue experimentation.

References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to implement such feature, structure, or characteristic in connection with other embodiments, whether or not explicitly described.

Although this disclosure has been described in terms of certain embodiments, alterations and permutations of the embodiments will be apparent to those skilled in the art. Accordingly, the above description of the embodiments does not constrain this disclosure. Other changes, substitutions, and alterations are possible without departing from the scope of this disclosure, as defined by the claims below.

Some example embodiments follow.

### Group A Embodiments

1. A method performed by a wireless device operating in dual connectivity with a first network node and as second network node, the method comprising:
   receiving a radio access network visible quality of experience (RVQoE) configuration associated with an application session;
   determining whether the application session is provided by communication with both the first network node and the second network node; and
   transmitting a RVQoE report for the application session based on the determination of whether the application session is provided by communication with both the first network node and the second network node.
2. The method of embodiment 1, wherein determining whether the application session is provided by communication with both the first network node and the second network node is based on an association the application session and one or more bearer channels.
3. The method of embodiment 1, wherein determining whether the application session is provided by communication with both the first network node and the second network node is performed according to any of the embodiments and examples described above.
4. The method of any one of the previous embodiments, wherein the RVQoE report is transmitted according to any of the embodiments and examples described herein.
5. A method performed by a wireless device, the method comprising:
   any of the wireless device steps, features, or functions described above, either alone or in combination with other steps, features, or functions described above.
6. The method of the previous embodiment, further comprising one or more additional wireless device steps, features or functions described above.
7. The method of any of the previous embodiments, further comprising:
   providing user data; and
   forwarding the user data to a host computer via the transmission to the base station.

### Group B Embodiments

8. A method performed by a first base station operating in dual connectivity with a second base station, the method comprising:
   configuring a wireless device with a radio access network visible quality of experience (RVQoE) configuration associated with an application session;
   determining whether the application session is provided by communication with both the first base station and the second base station; and
   receiving a RVQoE report for the application session based on the determination of whether the application session is provided by communication with both the first base station and the second base station.
9. The method of the previous embodiment, further comprising updating the RVQoE configuration for the wireless device based on the determination of whether the application session is provided by communication with both the first base station and the second base station.
10. The method of embodiment 8, wherein determining whether the application session is provided by communication with both the first base station and the second base station is based on an association the application session and one or more bearer channels.
11. The method of embodiment 1, wherein determining whether the application session is provided by communication with both the first base station and the second base station is performed according to any of the embodiments and examples described above.
12. The method of any one of the previous embodiments, wherein the RVQoE report is received according to any of the embodiments and examples described herein.
13. A method performed by a base station, the method comprising:
   any of the steps, features, or functions described above with respect to base station, either alone or in combination with other steps, features, or functions described above.
14. The method of the previous embodiment, further comprising one or more additional base station steps, features or functions described above.
15. The method of any of the previous embodiments, further comprising:
   obtaining user data; and
   forwarding the user data to a host computer or a wireless device.

### Group C Embodiments

16. A mobile terminal comprising:
   processing circuitry configured to perform any of the steps of any of the Group A embodiments; and
   power supply circuitry configured to supply power to the wireless device.
17. A base station comprising:
   processing circuitry configured to perform any of the steps of any of the Group B embodiments;
   power supply circuitry configured to supply power to the wireless device.
18. A user equipment (UE) comprising:
   an antenna configured to send and receive wireless signals;
   radio front-end circuitry connected to the antenna and to processing circuitry, and configured to condition signals communicated between the antenna and the processing circuitry;
   the processing circuitry being configured to perform any of the steps of any of the Group A embodiments;
   an input interface connected to the processing circuitry and configured to allow input of information into the UE to be processed by the processing circuitry;
   an output interface connected to the processing circuitry and configured to output information from the UE that has been processed by the processing circuitry; and
   a battery connected to the processing circuitry and configured to supply power to the UE.
19. A communication system including a host computer comprising:
   processing circuitry configured to provide user data; and
   a communication interface configured to forward the user data to a cellular network for transmission to a user equipment (UE),
   wherein the cellular network comprises a base station having a radio interface and processing circuitry, the base station's processing circuitry configured to perform any of the steps of any of the Group B embodiments.
20. The communication system of the pervious embodiment further including the base station.
21. The communication system of the previous 2 embodiments, further including the UE, wherein the UE is configured to communicate with the base station.
22. The communication system of the previous 3 embodiments, wherein:
   the processing circuitry of the host computer is configured to execute a host application, thereby providing the user data; and
   the UE comprises processing circuitry configured to execute a client application associated with the host application.
23. A method implemented in a communication system including a host computer, a base station and a user equipment (UE), the method comprising:
   at the host computer, providing user data; and
   at the host computer, initiating a transmission carrying the user data to the UE via a cellular network comprising the base station, wherein the base station performs any of the steps of any of the Group B embodiments.
24. The method of the previous embodiment, further comprising, at the base station, transmitting the user data.
25. The method of the previous 2 embodiments, wherein the user data is provided at the host computer by executing a host application, the method further comprising, at the UE, executing a client application associated with the host application.
26. A user equipment (UE) configured to communicate with a base station, the UE comprising a radio interface and processing circuitry configured to performs any of the previous 3 embodiments.
27. A communication system including a host computer comprising:
   processing circuitry configured to provide user data; and
   a communication interface configured to forward user data to a cellular network for transmission to a user equipment (UE),
   wherein the UE comprises a radio interface and processing circuitry, the UE's components configured to perform any of the steps of any of the Group A embodiments.
28. The communication system of the previous embodiment, wherein the cellular network further includes a base station configured to communicate with the UE.
29. The communication system of the previous 2 embodiments, wherein:
   the processing circuitry of the host computer is configured to execute a host application, thereby providing the user data; and
   the UE's processing circuitry is configured to execute a client application associated with the host application.
30. A method implemented in a communication system including a host computer, a base station and a user equipment (UE), the method comprising:
   at the host computer, providing user data; and
   at the host computer, initiating a transmission carrying the user data to the UE via a cellular network comprising the base station, wherein the UE performs any of the steps of any of the Group A embodiments.
31. The method of the previous embodiment, further comprising at the UE, receiving the user data from the base station.
32. A communication system including a host computer comprising:
   communication interface configured to receive user data originating from a transmission from a user equipment (UE) to a base station,
   wherein the UE comprises a radio interface and processing circuitry, the UE's processing circuitry configured to perform any of the steps of any of the Group A embodiments.
33. The communication system of the previous embodiment, further including the UE.
34. The communication system of the previous 2 embodiments, further including the base station, wherein the base station comprises a radio interface configured to communicate with the UE and a communication interface configured to forward to the host computer the user data carried by a transmission from the UE to the base station.
35. The communication system of the previous 3 embodiments, wherein:
   the processing circuitry of the host computer is configured to execute a host application; and
   the UE's processing circuitry is configured to execute a client application associated with the host application, thereby providing the user data.
36. The communication system of the previous 4 embodiments, wherein:
   the processing circuitry of the host computer is configured to execute a host application, thereby providing request data; and
   the UE's processing circuitry is configured to execute a client application associated with the host application, thereby providing the user data in response to the request data.
37. A method implemented in a communication system including a host computer, a base station and a user equipment (UE), the method comprising:
   at the host computer, receiving user data transmitted to the base station from the UE, wherein the UE performs any of the steps of any of the Group A embodiments.
38. The method of the previous embodiment, further comprising, at the UE, providing the user data to the base station.
39. The method of the previous 2 embodiments, further comprising:
   at the UE, executing a client application, thereby providing the user data to be transmitted; and
   at the host computer, executing a host application associated with the client application.
40. The method of the previous 3 embodiments, further comprising:
   at the UE, executing a client application; and
   at the UE, receiving input data to the client application, the input data being provided at the host computer by executing a host application associated with the client application,
   wherein the user data to be transmitted is provided by the client application in response to the input data.
41. A communication system including a host computer comprising a communication interface configured to receive user data originating from a transmission from a user equipment (UE) to a base station, wherein the base station comprises a radio interface and processing circuitry, the base station's processing circuitry configured to perform any of the steps of any of the Group B embodiments.
42. The communication system of the previous embodiment further including the base station.
43. The communication system of the previous 2 embodiments, further including the UE, wherein the UE is configured to communicate with the base station.
44. The communication system of the previous 3 embodiments, wherein:
   the processing circuitry of the host computer is configured to execute a host application;
   the UE is configured to execute a client application associated with the host application, thereby providing the user data to be received by the host computer.
45. A method implemented in a communication system including a host computer, a base station and a user equipment (UE), the method comprising:
   at the host computer, receiving, from the base station, user data originating from a transmission which the base station has received from the UE, wherein the UE performs any of the steps of any of the Group A embodiments.
46. The method of the previous embodiment, further comprising at the base station, receiving the user data from the UE.
47. The method of the previous 2 embodiments, further comprising at the base station, initiating a transmission of the received user data to the host computer.

1.-30. (canceled)

31. A method performed by a wireless device operating in dual connectivity with a first network node and a second network node, the method comprising:
receiving a radio access network visible quality of experience, RVQoE, configuration associated with an application session;
determining whether the application session is provided by communication with both the first network node and the second network node; and
transmitting a RVQoE report for the application session based on the determination of whether the application session is provided by communication with both the first network node and the second network node.

32. The method of claim 31, wherein determining whether the application session is provided by communication with both the first network node and the second network node comprises receiving a reporting configuration in the RVQoE configuration indicating whether RVQoE reporting is towards the first network node, the second network node, or both the first and second network node.

33. The method of claim 31, wherein determining whether the application session is provided by communication with both the first network node and the second network node comprises receiving a reporting configuration in the RVQoE configuration indicating whether RVQoE reporting is towards the first network node or the second network node.

34. The method of claim 31, wherein determining whether the application session is provided by communication with both the first network node and the second network node is based on an association between the application session and one or more bearer channels.

35. The method of claim 34, further comprising:
transmitting the association between the application session and one or more bearer channels to one or both of the first network node and the second network node; and
receiving from one or both of the first network node and the second network node an updated RVQoE configuration comprising a reporting configuration indicating whether RVQoE reporting is towards the first network node, the second network node, or both the first and second network node based on the association between the application session and one or more bearer channels.

36. The method of claim 31, wherein receiving the RVQoE configuration occurs after a start of the application session, and the RVQoE configuration comprises an indication of whether RVQoE reporting is towards the first network node, the second network node, or both the first and second network node based on protocols used by the application session.

37. The method of claim 31, wherein receiving the RVQoE configuration occurs after a start of the application session, and after a first RVQoE report has been transmitted by the wireless device, and the RVQoE configuration comprises an indication of whether RVQoE reporting is towards the first network node, the second network node, or both the first and second network node based on the first RVQoE report.

38. A wireless device capable of operating in dual connectivity with a first network node and a second network node, the wireless device comprising processing circuitry operable to:
receive a radio access network visible quality of experience, RVQoE, configuration associated with an application session;
determine whether the application session is provided by communication with both the first network node and the second network node; and
transmit a RVQoE report for the application session based on the determination of whether the application session is provided by communication with both the first network node and the second network node.

39. The wireless device of claim 38, wherein the wireless device comprising processing circuitry operable to determine whether the application session is provided by communication with both the first network node and the second network node comprises the wireless device comprising processing circuitry operable to receive a reporting configuration in the RVQoE configuration indicating whether RVQoE reporting is towards the first network node, the second network node, or both the first and second network node.

40. A method performed by a first network node operating in dual connectivity with a second network node, the method comprising:
determining whether an application session is provided by communication with both the first network node and the second network node;
configuring a wireless device with a radio access network visible quality of experience, RVQoE, configuration associated with the application session, the RVQoE configuration comprising a reporting configuration indicating whether RVQoE reporting is towards the first network node, the second network node, or both the first and second network node based on whether the application session is provided by communication with both the first network node and the second network node; and
receiving a RVQoE report for the application session from the wireless device based on the reporting configuration.

41. The method of claim 40, wherein determining whether the application session is provided by communication with both the first network node and the second network node is based on an association between the application session and one or more bearer channels.

42. The method of claim 40, wherein determining whether the application session is provided by communication with both the first network node and the second network node comprises receiving the association between the application session and one or more bearer channels from the wireless device.

43. The method of claim 40, wherein determining whether the application session is provided by communication with both the first network node and the second network node is based on protocols used by the application session.

44. The method of claim 40, wherein determining whether the application session is provided by communication with both the first network node and the second network node occurs after a first RVQoE report has been transmitted by the wireless device and the determination is based on the first RVQoE report.

45. The method of claim 40, wherein the first network node comprises a master node, MN, and the second network node comprises a secondary node, SN, or the first network node comprises a SN and the second network node comprises a MN.

46. The method of claim 40, further comprising forwarding the received RVQoE report to the second network node.

47. A first network node capable of operating in dual connectivity with a second network node, the first network node comprising processing circuitry operable to:
determine whether an application session is provided by communication with both the first network node and the second network node;
configure a wireless device with a radio access network visible quality of experience, RVQoE, configuration associated with the application session, the RVQoE configuration comprising a reporting configuration indicating whether RVQoE reporting is towards the first network node, the second network node, or both the first and second network node based on whether the application session is provided by communication with both the first network node and the second network node; and
receive a RVQoE report for the application session from the wireless device based on the reporting configuration.

48. The first network node of claim 47, wherein the processing circuitry is operable to determine whether the application session is provided by communication with both the first network node and the second network node based on an association between the application session and one or more bearer channels.
